(19) United States
(12) Patent Application Publication
(10) Pub. No.: US 2017/0048180 A1
(43) Pub. Date: Feb. 16, 2017

(54) DEVICE AND METHOD FOR PROVIDING MESSAGE SERVICE

(71) Applicant: SAMSUNG ELECTRONICS CO., LTD., Suwon-si, Gyeonggi-do (KR)

(72) Inventors: Bo-Seong KIM, Gyeonggi-do (KR); Joo-Yeon KIM, Gyeonggi-do (KR); Beom-Jun LEE, Gyeonggi-do (KR); Seung-Jae LEE, Seoul (KR); Jae-Young LEE, Seoul (KR); Sang-Ho CHAE, Gyeonggi-do (KR)

(73) Assignee: Samsung Electronics Co., Ltd.

(21) Appl. No.: 15/306,485

(22) PCT Filed: Apr. 17, 2015
(86) PCT No.: PCT/KR2015/003892

§ 371 Date: Oct. 24, 2016

(30) Foreign Application Priority Data
Apr. 24, 2014 (KR) 10-2014-0049473

(51) Int. Cl. H04L 12/58

(52) U.S. Cl. CPC H04L 51/18

(57) ABSTRACT

Various examples relating to a device and a method for providing a message service are provided. A message service method, according to one example, comprises the steps of: receiving, from a transmission terminal, a cancelation request for canceling a transmission message transmitted to at least one reception terminal; determining whether the transmission message for each of the at least one reception terminal can be cancelled; and transmitting a transmission message cancelation command signal to a reception terminal for which the transmission message can be cancelled among the at least one reception terminal, wherein the at least one reception terminal is capable of including a plurality of terminals associated with the same user account. Various examples can be implemented in addition to the one example.

### TECHNICAL FIELD

Various embodiments of the present invention relate to a message service.

### BACKGROUND ART

In recent years, a message service has been provided as a useful method for an electronic device to deliver information in real time. The message service is intended to deliver a simple message in real time between users. The message service may be provided through a messenger application. The messenger application enables two users or a plurality of users, for example, three or more users, to chat in real time through delivered texts as if directly chatting. For example, the messenger application enables one-to-one chatting between two users through message transmissions and receptions or enables group chatting between a plurality of users, for example, three or more users, through message transmissions and receptions. Messages exchanged between users may be chronologically accumulated and stored in a messenger, and each of the users may import and identify messages exchanged in the past. Such a message service technology may also be provided through a mobile electronic device, and a mobile messaging technology is evolving to enable the transmission and reception of multimedia messages in addition to a function of exchanging text messages.

Particularly, in addition to a function of simply exchanging messages, a function of canceling a sent message has been required in recent years. A message cancelation function is a function enabling a transmitter that sends a message to cancel a message sent to a recipient that receives a message and may be used when the transmitter wishes to cancel a sent message.

### DETAILED DESCRIPTION OF THE INVENTION

### Technical Problem

However, a conventional message cancelation function is not available in an N screen service. The N screen service is a network service that enables a plurality of electronic devices to use the same content. For example, the N screen service may enable a plurality of electronic devices to use a messenger application using one account. However, the conventional message cancelation function makes it impossible for an electronic device linked to the N screen service to cancel a message since it is not considered that a transmitter that sends a message or a recipient that receives a message is in the N screen service.

Further, the conventional message cancelation function may allow the cancelation of a message only before a recipient that receives a message reads the message. Thus, in conventional message cancelation, it is impossible to cancel a message when the recipient has read the message. Accordingly, the conventional message cancelation function makes it impossible to cancel a message when there is a plurality of recipients that have received the message as in a group chat room in which even one recipient has read the message.

### Technical Solution

Therefore, various embodiments of the present invention mentioned above may provide a device and a method for providing a message service that make it possible to cancel a message even while a transmitter or a recipient that exchanges messages is in an N screen service.

Further, various embodiments of the present invention may provide a device and a method for providing a message service that are capable of canceling a message even when a recipient has read the message.

In addition, various embodiments of the present invention may provide a device and a method for providing a message service that allow each of a plurality of recipients to cancel a message even when there is a plurality of recipients that has received the message as in a group chat room in which there is a recipient that has read the message among the recipients.

According to various embodiments of the present invention, a message service method may include: receiving, from a transmission terminal, a cancelation request for canceling a transmission message transmitted to at least one or more reception terminals; determining whether it is possible to cancel the transmission message for each of the at least one or more reception terminals; and transmitting a transmission message cancelation command signal to a reception terminal for which it is possible to cancel the transmission message among the at least one or more reception terminals, wherein the at least one or more reception terminals may include a plurality of terminals associated with the same user account. According to various embodiments of the present invention, a message server may include: a transceiver that receives, from a transmission terminal, a cancelation request for canceling a transmission message transmitted to at least one or more reception terminals; and a controller that controls to determine whether it is possible to cancel the transmission message for each of the at least one or more reception terminals and to transmit a transmission message cancelation command signal to a reception terminal for which it is possible to cancel the transmission message among the at least one or more reception terminals, wherein the at least one or more reception terminals may include a plurality of terminals associated with the same user account.

According to various embodiments of the present invention, a terminal may include: a display; a communication unit that receives a transmission message and receives a cancelation command signal for the transmission message; and a processor that, according to the cancelation command signal for the transmission message, processes the transmission message not to be displayed on the display when the transmission message has been read, and displays a message indicating that the transmission message has been canceled on the display, instead of displaying the transmission message, when the transmission message has not been read.

According to various embodiments of the present invention, a terminal may include: a display; a communication unit that transmits a message cancelation request for canceling a transmission message transmitted to at least one or more reception terminals; and a processor that, according to the cancelation request, displays a message indicating that message cancelation is impossible on the display when a message cancelation impossible signal is received, and displays a message cancelation completion signal on the display when the message cancelation completion signal is received.

According to various embodiments of the present invention, a message service system may include: a transmission terminal that transmits a cancelation request for canceling a transmission message transmitted to at least one or more reception terminals; a message server that determines whether it is possible to cancel the transmission message for each of the at least one or more reception terminals and transmits a transmission message cancelation command signal to a reception terminal for which it is possible to cancel the transmission message among the at least one or more reception terminals; and the at least one or more reception terminals that cancel a received message according to the transmission message cancelation command signal, wherein the at least one or more reception terminals may include a plurality of terminals associated with the same user account.

According to various embodiments of the present invention, a message service method may include: receiving, from a transmission terminal, a cancelation request for canceling a transmission message transmitted to at least one or more reception terminals in a group chat room; determining whether it is possible to cancel the transmission message for each of the at least one or more reception terminals belonging to the group chat room; and transmitting a transmission message cancelation command signal to a reception terminal for which it is possible to cancel the transmission message among the at least one or more reception terminals belonging to the group chat room, wherein the at least one or more reception terminals may include a plurality of terminals associated with the same user account.

According to various embodiments of the present invention, it is possible to cancel a message even while a transmitter or a recipient that exchanges messages is in an N screen service.

Further, according to various embodiments of the present invention, it is possible to cancel a message even when a recipient has read the message, which is convenient.

In addition, according to various embodiments of the present invention, even when there is a plurality of recipients that has received a message as in a group chat room in which there is a recipient that has read the message among the recipients, it is possible for each of the recipients to cancel the message and it is possible to indicate a message cancelation status of each of the recipients, which is convenient.

### BRIEF DESCRIPTION OF THE DRAWINGS

FIG. 1 is a schematic diagram of a message service system according to a first embodiment of the present invention;

FIG. 2 is a flowchart illustrating message cancelation in the message service system according to the first embodiment of the present invention;

FIG. 3 is a schematic diagram of a message service system according to a second embodiment of the present invention;

FIG. 4 is a flowchart illustrating message cancelation in the message service system according to the second embodiment of the present invention;

FIG. 5 is a schematic diagram of a message service system according to a third embodiment of the present invention;

FIG. 6 is a flowchart illustrating message cancelation in the message service system according to the third embodiment of the present invention;

FIG. 7 is a block diagram illustrating a configuration of a message server according to various embodiments of the present invention;

FIG. 8 and FIG. 9 are flowcharts illustrating a message cancelation operation of a message server according to the first embodiment of the present invention;

FIG. 10 and FIG. 11 are flowcharts illustrating a message cancelation operation of a message server according to the second embodiment of the present invention;

FIG. 12 illustrates a network environment including an electronic device according to various embodiments of the present invention;

FIG. 13 is a flowchart illustrating a message cancelation request operation of an electronic device according to an embodiment of the present invention;

FIG. 14 is a flowchart illustrating a message cancelation operation of an electronic device according to an embodiment of the present invention;

FIG. 15 illustrates a user interface screen displayed when a message cancelation request is made in an electronic device according to an embodiment of the present invention;

FIG. 16 illustrates a user interface screen displayed when a message is canceled in an electronic device according to an embodiment of the present invention; and

FIG. 17 illustrates a user interface screen displayed when a message cancelation request is made during a group chat in an electronic device according to an embodiment of the present invention.

### MODE FOR CARRYING OUT THE INVENTION

Hereinafter, various embodiments of the present invention will be described with reference to the accompanying drawings. The present invention may have various modifications and embodiments and thus will be described in detail with reference to specific embodiments illustrated in the drawings. However, it should be understood that there is no intent to limit the present invention to the particular forms disclosed herein; rather, the present invention should be construed to cover all modifications, equivalents, and/or alternatives falling within the spirit and scope of the invention. In connection with descriptions of the drawings, like reference numerals designate like elements.

In the present invention, the expression “include” or “may include” refers to existence of a corresponding function, operation, or element, and does not limit one or more additional functions, operations, or elements. In the present invention, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present invention includes any or all of combinations of listed words. For example, the expression “A or B” may include A, may include B, or may include both A and B.

In the present invention, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, without departing from the scope of the present invention, a first component element may be named a second component element. Similarly, the second component element also may be named the first component element.

In the case where an element is referred to as being “connected” or “accessed” to other elements, it should be understood that not only the element is directly connected or accessed to the other elements, but also another element may exist between them. Contrarily, when an element is referred to as being “directly coupled” or “directly connected” to any other element, it should be understood that no element is interposed therebetween.

The terms in various embodiments of the present invention are used to describe a specific embodiment, and are not intended to limit the present invention. As used herein, the singular forms are intended to include the plural forms as well, unless the context clearly indicates otherwise.

Unless defined otherwise, all terms used herein, including technical and scientific terms, have the same meaning as commonly understood by those of skill in the art to which the present invention pertains. Such terms as those defined in a generally used dictionary are to be interpreted to have the meanings equal to the contextual meanings in the relevant field of art, and are not to be interpreted to have ideal or excessively formal meanings unless clearly defined in the present invention.

According to various embodiments of the present invention, a message service system may provide a message transmission/reception function between at least one electronic device. The electronic device may be a device that can provide a message service through a user and an interface. The term “user” used in various embodiments may refer to a person who uses an electronic device or a device (for example, an artificial intelligence electronic device) that uses an electronic device.

According to one embodiment, the electronic device may include at least one of a smart phone, a tablet Personal Computer (PC), a mobile phone, a video phone, an e-book reader, a desktop PC, a laptop PC, a netbook computer, a PDA, a Portable Multimedia Player (PMP), an MP3 player, a mobile medical device, a camera, a wearable device (for example, a Head-Mounted-Device (HMD) such as electronic glasses, electronic clothes, an electronic bracelet, an electronic necklace, an electronic appcessory, an electronic tattoo, and a smart watch.

According to some embodiments, the electronic device may be a smart home appliance. The smart home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to some embodiments, the electronic device may include at least one of various types of medical devices (for example, Magnetic Resonance Angiography (MRA), Magnetic Resonance Imaging (MRI), Computed Tomography (CT), a scanning machine, ultrasonic wave device and the like), a navigation device, a Global Positioning System (GPS) receiver, an Event Data Recorder (EDR), a Flight Data Recorder (FDR), a car infotainment device, ship electronic equipment (for example, navigation equipment for a ship, a gyro compass and the like), avionics, a security device, and an industrial or home robot.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device 100 according to various embodiments of the present invention may correspond to one of the aforementioned various devices or a combination thereof. Further, it is obvious to those skilled in the art that the electronic device 100 according to various embodiments of the present invention is not limited to the aforementioned devices.

According to various embodiments of the present invention, electronic devices may cancel messages transmitted and received through a message service system. According to one embodiment, canceling a message may mean the cancelation of the transmission of a message transmitted from a transmitting electronic device to a receiving electronic device. According to one embodiment, canceling a message may refer to withdrawing a message transmitted by a transmitting electronic device from a receiving electronic device or deleting a message transmitted by a transmitting electronic device and a message received by a receiving electronic device.

According to various embodiments of the present invention, each of the electronic devices may access a message server using each individual user account, may transmit or receive a message through the message server, and may cancel a sent message.

According to various embodiments of the present invention, when electronic devices that exchange messages through a message server are a plurality of electronic devices linked using one account, the electronic devices may also cancel a sent message. According to one embodiment, when electronic devices that exchange messages through a message server are electronic devices linked to an N screen service function, the electronic devices may also cancel a sent message.

According to various embodiments of the present invention, a transmitting electronic device that transmits a message may include at least one or more transmitting electronic devices, and a receiving electronic device that receives a message may include at least one or more receiving electronic devices.

According to various embodiments of the present invention, at least one or more transmitting electronic devices may include one transmission terminal that is capable of transmitting a message using one first user account or a plurality of transmission terminals that are linked using the one first user account to each transmit a message with the first user account as a sender. According to various embodiments of the present invention, at least one or more receiving electronic devices may include one reception terminal that is capable of receiving a message using one second user account or a plurality of reception terminals that are linked using the one second user account to each receive a message with the second user account as a recipient. According to one embodiment, a plurality of terminals linked using one user account may be terminals linked via an N screen service.

According to various embodiments of the present invention, a message service system may enable the cancelation of a message even when at least one or more transmitting electronic devices or at least one or more receiving electronic devices include a plurality of electronic devices linked using one user account (hereinafter, referred to as “electronic devices linked via an N screen service”). According to various embodiments of the present invention, a message transmitted and received between electronic devices may include various types of digital content, such as a text and multimedia data.

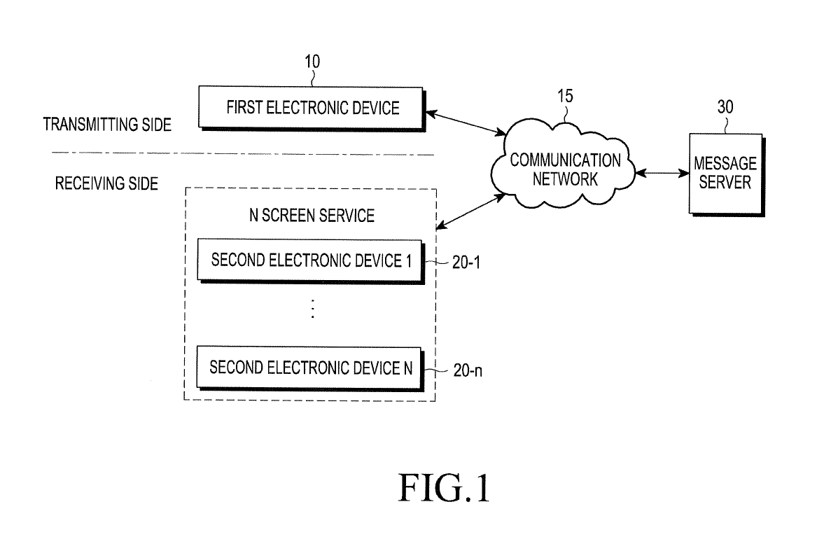

FIG. 1 is a schematic diagram of a message service system according to a first embodiment of the present invention.

Referring to FIG. 1, an electronic device of a transmitting side may be a first electronic device 10 using a first user account. An electronic device of a receiving side may be a second electronic device 1 20-1 to a second electronic device N 20-N that are linked via a second user account.

According to one embodiment, the first electronic device 10 and any one of the second electronic device 1 20-1 to the second electronic device N 20-N may each transmit and receive a message for a one-to-one chat between a user of the first user account and a user of the second user account using a message application.

The first electronic device 10 of the transmitting side may transmit a message and may transmit a cancelation request message requesting the cancelation of a sent message through a communication network 15 using a messenger application. According to one embodiment, the cancelation request message may include a message ID (msid) indicating a message to be canceled. When a message indicating the completion of message cancelation is received, the first electronic device 10 of the transmitting side may display information indicating a message cancelation notification.

The second electronic device 1 20-1 to the second electronic device N 20-N of the receiving side may be electronic devices linked using the same user account. According to one embodiment, the second electronic device 1 20-1 to the second electronic device N 20-N of the receiving side may be electronic devices linked with an N screen service. Each of the second electronic device 1 20-1 to the second electronic device N 20-N may be linked using the same user account to run a messenger application. Each of the second electronic device 1 20-1 to the second electronic device N 20-N may receive a message and may receive an UNDO message for requesting the cancelation of a received message through the messenger application. According to one embodiment, the UNDO message may include a Unique ID (UID) of a receiving electronic device, a chat room ID (Session ID), a transmitter ID (User ID), and a message ID (msID).

According to one embodiment, each of the second electronic device 1 20-1 to the second electronic device N 20-N may receive an UNDO message through a Transmission Control Protocol (TCP) if TCP communication is connected, or may receive an UNDO message through a PUSH message if TCP communication is not connected. When an UNDO message is received, each of the second electronic device 1 20-1 to the second electronic device N 20-N may cancel a received message.

According to one embodiment, in canceling a message, each of the second electronic device 1 20-1 to the second electronic device N 20-N may determine whether a message to be canceled has been read. If the message to be canceled has not been read, each of the second electronic device 1 20-1 to the second electronic device N 20-N may process the message to be canceled not to be displayed and may delete the stored message to be canceled. If the message to be canceled has been read, each of the second electronic device 1 20-1 to the second electronic device N 20-N may perform a process such that a message indicating that the message is canceled is displayed instead of the message to be canceled and may delete the stored message to be canceled. When a cancelation process is completed, each of the second electronic device 1 20-1 to the second electronic device N 20-N may transmit an UNDO acknowledgement (ACK) message to indicate that the message is canceled.

A message server 30 may receive a message cancelation request message requesting the cancelation of a message transmitted from the first electronic device 10 of the transmitting side. When the message cancelation request message is received, the message server 30 may determine whether it is possible to cancel the message to the second electronic device 1 20-1 to the second electronic device N 20-N. According to one embodiment, the message server 30 may check whether each of the second electronic device 1 20-1 to the second electronic device N 20-N is supportive of cancelation and may determine the possibility of message cancelation depending on the supportiveness of cancelation. For example, when there is a cancelation-unsupportive device among the second electronic device 1 20-1 to the second electronic device N 20-N, the message server 30 may determine that message cancelation is impossible; when there is no cancelation-unsupportive device, the message server 30 may determine that message cancelation is possible. According to one embodiment, the message server 30 may check whether each of the second electronic device 1 20-1 to the second electronic device N 20-N is supportive of cancelation and is in an idle state, and may determine the possibility of message cancelation depending on whether each of the second electronic device 1 20-1 to the second electronic device N 20-N is supportive of cancelation and is in an idle state. For example, when there is an electronic device that is unsupportive of cancelation and is not in the idle state among the second electronic device 1 20-1 to the second electronic device N 20-N, the message server 30 may determine that message cancelation is impossible. When there is no electronic device that is unsupportive of cancelation and is not in the idle state, the message server 30 may determine that message cancelation is possible. Here, it may be determined that message cancelation is possible for an electronic device that is unsupportive of cancelation and is in the idle state.

When it is determined that message cancelation is impossible, the message server 30 may notify the first electronic device 10 of the transmitting side that cancelation is impossible. When it is determined that message cancelation is possible, the message server 30 may transmit an UNDO message to each of the second electronic device 1 20-1 to the second electronic device N 20-N. When a message received by each of the second electronic device 1 20-1 to the second electronic device N 20-N is canceled by the transmitted UNDO message, the message server 30 may receive an UNDO ACK message from each of the second electronic device 1 20-1 to the second electronic device N 20-N.

When the UNDO ACK message is received from all of the second electronic device 1 20-1 to the second electronic device N 20-N, the message server 30 may determine that message cancelation is completed. According to another embodiment, when an UNDO ACK message is received from all devices for which message cancelation is possible among the second electronic device 1 20-1 to the second electronic device N 20-N, the message server 30 may determine that message cancelation is completed. When message cancelation is completed, the message server 30 may transmit an UNDO CONFIRM message indicating the completion of message cancelation to the first electronic device 10 of the transmitting side. According to one embodiment, the UNDO CONFIRM message may include a Unique ID (UID) of a transmitting electronic device, a chat room ID (Session ID), a receiver ID (User ID), and a message ID (msID).

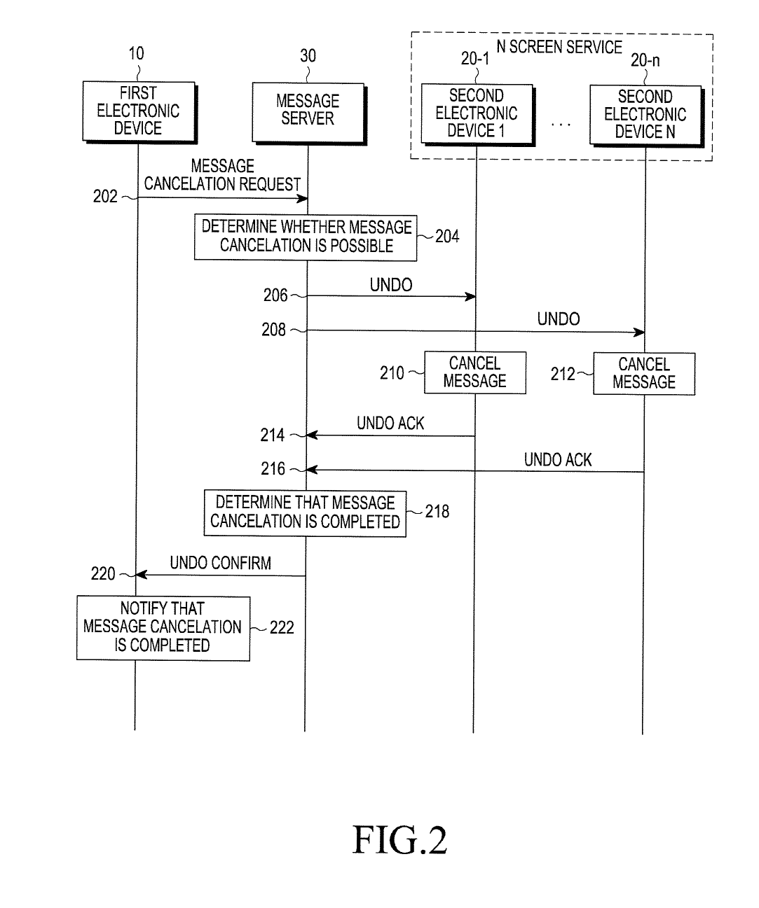

FIG. 2 is a flowchart illustrating message cancelation in the message service system according to the first embodiment of the present invention. Referring to FIG. 2, the first electronic device 10 may transmit a message cancelation request message requesting the cancelation of a sent message in operation 202. According to one embodiment, the message cancelation request message may include a message ID (msid) indicating a message to be canceled.

When the message cancelation request message is received, the message server 30 may determine whether message cancelation is possible in operation 204.

According to one embodiment, the message server 30 may determine at least one or more receiving electronic devices that have received the message to be canceled using the ID of the message to be canceled that is included in the message cancelation request message. The message server 30 may determine the possibility of message cancelation depending on whether each of the second electronic device 1 20-1 to the second electronic device N 20-N that are linked to the N service is a cancelation-supportive device or may determine the possibility of message cancelation depending on whether each of the second electronic device 1 20-1 to the second electronic device N 20-N is a cancelation-supportive device and is in the idle state.

According to one embodiment, when determining the possibility of message cancelation depending on the supportiveness of cancelation, the message server 30 may check whether each of the second electronic device 1 20-1 to the second electronic device N 20-N is a cancelation-supportive device or cancelation-unsupportive device. When there is a cancelation-unsupportive device among the second electronic device 1 20-1 to the second electronic device N 20-N, the message server 30 determines that message cancelation is impossible. When there is no cancelation-unsupportive device, the message server 30 may determine that message cancelation is possible. In this case, when there is even one cancelation-unsupportive electronic device among the second electronic device 1 20-1 to the second electronic device N 20-N, the message server 30 may determine that message cancelation is impossible. Alternatively, when there is a cancelation-supportive device among the second electronic device 1 20-1 to the second electronic device N 20-N, the message server 30 may determine that message cancelation is possible. When there is no cancelation-supportive device, the message server 30 may determine that message cancelation is impossible. In this case, when there is even one cancelation-supportive electronic device, the message server 30 may determine that message cancelation is possible.

According to another embodiment, when determining the possibility of message cancelation depending on whether each of the second electronic device 1 20-1 to the second electronic device N 20-N is a cancelation-supportive device and is in the idle state, the message server 30 may check whether each of the second electronic device 1 20-1 to the second electronic device N 20-N is a cancelation-supportive device and is in the idle state. The message server 30 may determine a cancelation-supportive electronic device as a message cancelation-possible electronic device. The message server 30 may determine an electronic device that is unsupportive of cancelation and is in the idle state as a message cancelation-possible electronic device, and may determine an electronic device that is unsupportive of cancelation and is not in the idle state as a message cancelation-impossible electronic device.

According to one embodiment, when there is a message cancelation-impossible electronic device among the second electronic device 1 20-1 to the second electronic device N 20-N, the message server 30 may determine that message cancelation is impossible. In this case, when there is even one message cancelation-impossible electronic device, it may be determined that message cancelation is impossible. According to another embodiment, when there is a message cancelation-possible electronic device, the message server 30 may determine that message cancelation is possible. In this case, when there is even one message cancelation-possible electronic device, it may be determined that message cancelation is possible.

When it is determined that message cancelation is impossible, the message server 30 may notify the first electronic device 10 of the transmitting side that cancelation is impossible. When it is determined that message cancelation is possible, the message server 30 may transmit an UNDO message to each of the second electronic device 1 20-1 to the second electronic device N 20-N or each message cancelation-possible electronic device among the second electronic device 1 20-1 to the second electronic device N 20-N in operations 206 and 208. According to one embodiment, the message server 30 may identify whether each of the second electronic device 1 20-1 to the second electronic device N 20-N is connected to TCP communication, and may transmit an UNDO message through a TCP if TCP communication is connected, or may transmit an UNDO message through a PUSH message if TCP communication is not connected. According to one embodiment, the UNDO message may include a Unique ID (UID) of a receiving electronic device, a chat room ID (Session ID), a transmitter ID (User ID), and a message ID (msID).

When the UNDO message is received, each of the second electronic device 1 20-1 to the second electronic device N 20-N may cancel a message in operations 210 and 212. According to one embodiment, in canceling a message, each of the second electronic device 1 20-1 to the second electronic device N 20-N may determine a message to be canceled using the chat room ID and the message ID included in the UNDO message. According to one embodiment, in canceling a message, each of the second electronic device 1 20-1 to the second electronic device N 20-N may determine whether the message to be canceled has been read. When the message to be canceled has not been read, each of the second electronic device 1 20-1 to the second electronic device N 20-N may process the message to be canceled not to be displayed and may delete the stored message to be canceled. When the message to be canceled has been read, each of the second electronic device 1 20-1 to the second electronic device N 20-N may perform a process such that a message indicating that the message is canceled is displayed instead of the message to be canceled and may delete the stored message to be canceled.

When a message cancelation process is completed, each of the second electronic device 1 20-1 to the second electronic device N 20-N may transmit an UNDO ACK message to the message server 30 to indicate that the message is canceled in operations 214 and 216.

When the UNDO ACK message is received from each of the second electronic device 1 20-1 to the second electronic device N 20-N, the message server 30 may determine that message cancelation is completed in operation 218. According to one embodiment, when the UNDO ACK message is received from all of the second electronic device 1 20-1 to the second electronic device N 20-N, the message server 30 may determine that message cancelation is completed. According to another embodiment, when an UNDO ACK message is received from all message cancelation-possible electronic devices among the second electronic device 1 20-1 to the second electronic device N 20-N, the message server 30 may determine that message cancelation is completed.

When it is determined that message cancelation is completed, the message server 30 may transmit an UNDO CONFIRM message indicating the completion of message cancelation to the first electronic device 10 of the transmitting side in operation 220. According to one embodiment, the UNDO CONFIRM message may include a Unique ID (UID) of a transmitting electronic device, a chat room ID (Session ID), a receiver ID (User ID), and a message ID (msID).

When the UNDO CONFIRM message indicating the completion of message cancelation is received, the first electronic device 10 of the transmitting side may display information indicating a message cancelation notification in operation 222.

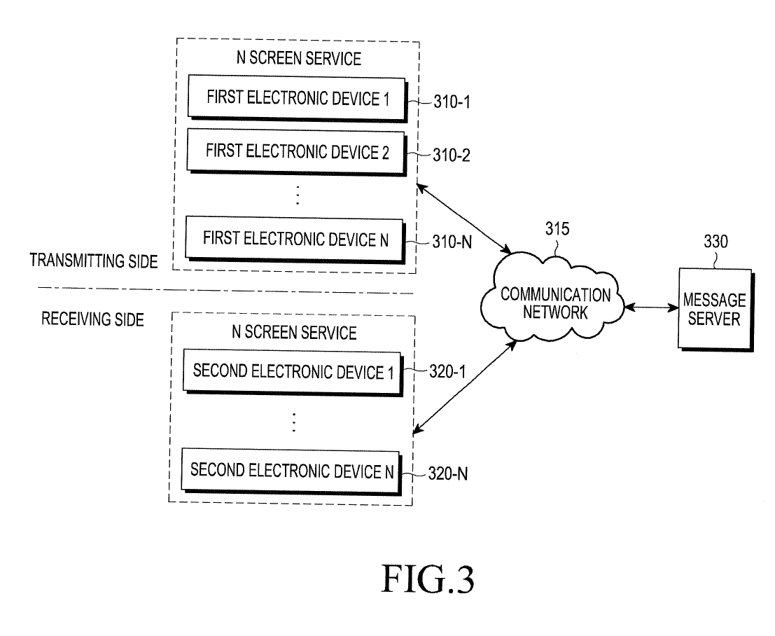

FIG. 3 is a schematic diagram of a message service system according to a second embodiment of the present invention.

Referring to FIG. 3, a first electronic device 1 310-1 to a first electronic device N 310-N of a transmitting side may be electronic devices that are linked via an N service, that is, linked using the same first user account, and a second electronic device 1 320-1 to a second electronic device N 320-N of a receiving side may be electronic devices that are linked via an N service, that is, linked using the same second user account. Any one of the first electronic device 1 310-1 to the first electronic device N 310-N and any one of the second electronic device 1 320-1 to the second electronic device N 320-N may each transmit and receive a message for a one-to-one chat using a message application.

Any one (hereinafter, assumed to be the first electronic device 1 310-1) of the first electronic device 1 310-1 to the first electronic device N 310-N of the transmitting side may transmit a message through a communication network 315 using a messenger application. The first electronic device 1 310-1 may request the cancelation of the transmitted message, and may display information indicating a message cancelation notification upon receiving a message indicating the completion of message cancelation.

Each of the first electronic device 2 310-2 to the first electronic device N 310-N linked to the first electronic device 1 310-1 using the same account may receive a message transmitted by the first electronic device 1 310-1 and may receive an UNDO message requesting the cancelation of the transmission of a sent message. Each of the first electronic device 2 310-2 to the first electronic device N 310-N may receive an UNDO message through a TCP if TCP communication is connected, or may receive an UNDO message through a PUSH message if TCP communication is not connected. When an UNDO message is received, each of the first electronic device 2 310-2 to the first electronic device N 310-N may cancel the transmission of a sent message. According to one embodiment, each of the first electronic device 2 310-2 to the first electronic device N 310-N may delete a record of a sent message and may display a message indicating the cancelation of transmission.

Meanwhile, each of the second electronic device 1 320-1 to the second electronic device N 320-N of the receiving side may receive a message and may receive an UNDO message requesting the cancelation of a received message. According to one embodiment, when an UNDO message is received, each of the second electronic device 1 320-1 to the second electronic device N 320-N may cancel a received message. According to one embodiment, each of the second electronic device 1 320-1 to the second electronic device N 320-N may cancel a received message depending on whether the message to be canceled has been read. According to one embodiment, when the message to be canceled has not been read, each of the second electronic device 1 320-1 to the second electronic device N 320-N may process the message to be canceled not to be displayed and may delete the stored message to be canceled. When the message to be canceled has been read, each of the second electronic device 1 320-1 to the second electronic device N 320-N may perform a process such that a message indicating that the message is canceled is displayed instead of the message to be canceled and may delete the stored message to be canceled. When a cancelation process is completed, each of the second electronic device 1 320-1 to the second electronic device N 320-N may transmit an UNDO ACK message to indicate that the message is canceled.

A message server 330 may receive a message cancelation request message requesting the cancelation of a message transmitted from the first electronic device 1 310-1. When the message cancelation request message is received, the message server 330 may determine whether it is possible to cancel the message.

According to one embodiment, the message server 330 may determine the possibility of message cancelation for each of the second electronic device 1 320-1 to the second electronic device N 320-N of the receiving side and the possibility of message cancelation for each of the first electronic device 2 310-2 to the first electronic device N 310-N linked with the first electronic device 1 310-1 of the transmitting side using the same account.

First, in determining the possibility of message cancelation for each of the second electronic device 1 320-1 to the second electronic device N 320-N of the receiving side, the message server 330 may determine the possibility of message cancelation depending on whether each of the second electronic device 1 320-1 to the second electronic device N 320-N is supportive of cancelation or may determine the possibility of message cancelation depending on whether each of the second electronic device 1 320-1 to the second electronic device N 320-N is supportive of cancelation and is in the idle state.

According to one embodiment, when determining the possibility of message cancelation depending on whether each of the second electronic device 1 320-1 to the second electronic device N 320-N is supportive of cancelation, the message server 330 may check whether each of the second electronic device 1 320-1 to the second electronic device N 320-N is a cancelation-supportive device or a cancelation-unsupportive device. When there is a cancelation-unsupportive device among the second electronic device 1 320-1 to the second electronic device N 320-N, the message server 330 may determine that message cancelation is impossible; when there is no cancelation-unsupportive device, the message server 330 may determine that message cancelation is possible. In this case, when there is even one cancelation-unsupportive electronic device among the second electronic device 1 320-1 to the second electronic device N 320-N, the message server 330 may determine that message cancelation is impossible. Alternatively, when there is a cancelation-supportive device among the second electronic device 1 320-1 to the second electronic device N 320-N, the message server 330 may determine that message cancelation is possible. When there is no cancelation-supportive device, the message server 330 may determine that message cancelation is impossible. In this case, when there is even one cancelation-supportive electronic device, the message server 330 may determine that message cancelation is possible.

According to another embodiment, when determining the possibility of message cancelation depending on whether each of the second electronic device 1 320-1 to the second electronic device N 320-N is supportive of cancelation and is in the idle state, the message server 330 may check whether each of the second electronic device 1 320-1 to the second electronic device N 320-N is a cancelation-supportive device and is in the idle state. The message server 330 may determine a cancelation-supportive electronic device as a message cancelation-possible electronic device. The message server 330 may determine an electronic device that is unsupportive of cancelation and is in the idle state as a message cancelation-possible electronic device, and may determine an electronic device that is unsupportive of cancelation and is not in the idle state as a message cancelation-impossible electronic device.

According to one embodiment, when there is a message cancelation-impossible electronic device among the second electronic device 1 320-1 to the second electronic device N 320-N, the message server 330 may determine that message cancelation for the receiving electronic devices is impossible. In this case, when there is even one message cancelation-impossible electronic device among the receiving devices, it may be determined that message cancelation for the receiving electronic devices is impossible. According to another embodiment, when there is a message cancelation-possible electronic device among the receiving electronic devices, the message server 330 may determine that message cancelation for the receiving electronic devices is possible. In this case, when there is even one message cancelation-possible electronic device among the receiving electronic devices, it may be determined that message cancelation is possible.

Meanwhile, similarly to the receiving side, the message server 330 may also determine the possibility of message cancelation for each of the first electronic device 2 310-2 to the first electronic device N 310-N linked with the first electronic device 1 310-1 of the transmitting side using the same account. In determining the possibility of message cancelation for each of the first electronic device 2 310-2 to the first electronic device N 310-N of the transmitting side, the message server 330 may determine the possibility of message cancelation depending on whether each of the first electronic device 2 310-2 to the first electronic device N 310-N is supportive of cancelation or may determine the possibility of message cancelation depending on whether each of the first electronic device 2 310-2 to the first electronic device N 310-N is supportive of cancelation and is in the idle state.

According to one embodiment, when there is a message cancelation-impossible electronic device among the first electronic device 2 310-2 to the first electronic device N 310-N of the transmitting side, the message server 330 may determine that message cancelation for the transmitting electronic devices is impossible. In this case, when there is even one message cancelation-impossible electronic device among the transmitting electronic devices, it may be determined that message cancelation for the transmitting electronic devices is impossible. According to another embodiment, when there is a message cancelation-possible electronic device among the transmitting electronic devices, the message server 330 may determine that message cancelation for the transmitting electronic devices is possible. In this case, when there is even one message cancelation-possible electronic device among the transmitting electronic devices, it may be determined that message cancelation for the transmitting side is possible.

According to one embodiment, when it is determined that both message cancelation for the transmitting side and message cancelation for the receiving side are possible, the message server 330 may determine that message cancelation is possible. Otherwise, the message server 330 may determine that message cancelation is impossible. According to another embodiment, when it is determined that message cancelation for the receiving side is possible, the message server 330 may determine that message cancelation is possible. When it is determined that message cancelation for the receiving side is impossible, the message server 330 may determine that message cancelation is impossible.

When it is determined that message cancelation is impossible, the message server 330 may notify the first electronic device 1 310-1 of the transmitting side that cancelation is impossible.

When it is determined that message cancelation for the receiving side is possible, the message server 330 may transmit an UNDO message requesting the cancelation of a message to each of the second electronic device 1 320-1 to the second electronic device N 320-N of the receiving side. When it is determined that message cancelation for the transmitting side is possible, the message server 330 may transmit an UNDO message requesting the cancelation of transmission to each of the first electronic device 2 310-2 to the first electronic device N 310-N linked with the first electronic device 1 310-1 of the transmitting side using the same account. According to one embodiment, the UNDO message may include a Unique ID (UID) of a receiving electronic device, a chat room ID (Session ID), a transmitter ID (User ID), and a message ID (msID).

When a received message is canceled by each of the second electronic device 1 320-1 to the second electronic device N 320-N of the receiving side, the message server 330 may receive an UNDO ACK message from each of the second electronic device 1 320-1 to the second electronic device N 320-N. Also, when transmission is canceled by each of the first electronic device 2 310-2 to the first electronic device N 310-N of the transmitting side, the message server 330 may receive an UNDO ACK message from each of the first electronic device 2 310-2 to the first electronic device N 310-N.

When the UNDO ACK message is received from each of the second electronic device 1 320-1 to the second electronic device N 320-N, the message server 330 may determine that message cancelation is completed and may transmit an UNDO CONFIRM message indicating that the completion of message cancelation to the first electronic device 1 310-1 of the transmitting side. According to another embodiment, when determining the completion of cancelation, it may be considered whether an UNDO ACK message is received according to the cancelation of transmission by each of the first electronic device 2 310-2 to the first electronic device N 310-N of the transmitting side.

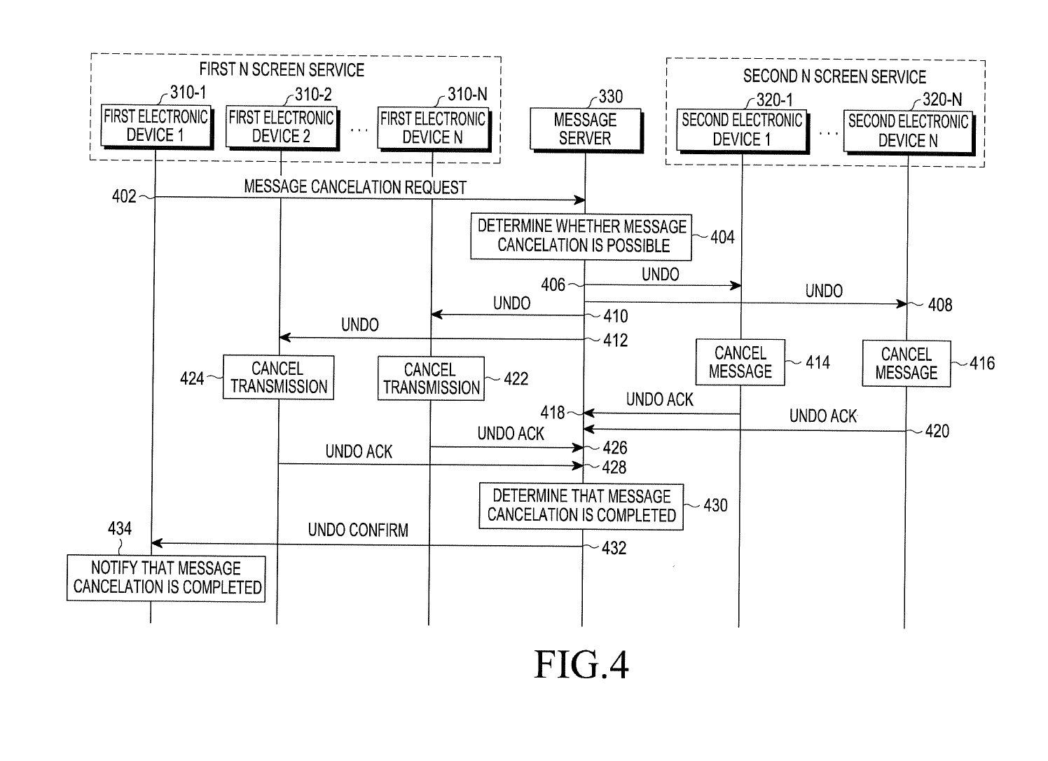

FIG. 4 is a flowchart illustrating message cancelation in the message service system according to the second embodiment of the present invention.

Referring to FIG. 4, any one of the first electronic device 1 310-1 to the first electronic device N 310-N of the transmitting side, for example, the first electronic device 1 310-1, may transmit a message cancelation request message for canceling a sent message to the message server 330 in operation 402. According to one embodiment, the message cancelation request message may include an ID of a message to be canceled.

When the message cancelation request message is received from the first electronic device 1 310-1, the message server 330 may determine whether message cancelation is possible in operation 404.

According to one embodiment, the message server 330 may determine the possibility of message cancelation for each of the second electronic device 1 320-1 to the second electronic device N 320-N of the receiving side and the possibility of message cancelation for each of the first electronic device 2 310-2 to the first electronic device N 310-N linked with the first electronic device 1 310-1 of the transmitting side using the same account.

First, in determining the possibility of message cancelation for each of the second electronic device 1 320-1 to the second electronic device N 320-N of the receiving side, the message server 330 may determine the possibility of message cancelation depending on whether each of the second electronic device 1 320-1 to the second electronic device N 320-N is supportive of cancelation or may determine the possibility of message cancelation depending on whether each of the second electronic device 1 320-1 to the second electronic device N 320-N is supportive of cancelation and is in the idle state.

According to one embodiment, when determining the possibility of message cancelation depending on whether each of the second electronic device 1 320-1 to the second electronic device N 320-N is supportive of cancelation, the message server 330 may check whether each of the second electronic device 1 320-1 to the second electronic device N 320-N is a cancelation-supportive device or a cancelation-unsupportive device. When there is a cancelation-unsupportive device among the second electronic device 1 320-1 to the second electronic device N 320-N, the message server 330 may determine that message cancelation is impossible; when there is no cancelation-unsupportive device, the message server 330 may determine that message cancelation is possible. In this case, when there is even one cancelation-unsupportive electronic device among the second electronic device 1 320-1 to the second electronic device N 320-N, the message server 330 may determine that message cancelation is impossible. Alternatively, when there is a cancelation-supportive device among the second electronic device 1 320-1 to the second electronic device N 320-N, the message server 330 may determine that message cancelation is possible. When there is no cancelation-supportive device, the message server 330 may determine that message cancelation is impossible. In this case, when there is even one cancelation-supportive electronic device, the message server 330 may determine that message cancelation is possible.

According to another embodiment, when determining the possibility of message cancelation depending on whether each of the second electronic device 1 320-1 to the second electronic device N 320-N is supportive of cancelation and is in the idle state, the message server 330 may check whether each of the second electronic device 1 320-1 to the second electronic device N 320-N is a cancelation-supportive device and is in the idle state. The message server 330 may determine a cancelation-supportive electronic device as a message cancelation-possible electronic device. The message server 330 may determine an electronic device that is unsupportive of cancelation and is in the idle state as a message cancelation-possible electronic device, and may determine an electronic device that is unsupportive of cancelation and is not in the idle state as a message cancelation-impossible electronic device.

According to one embodiment, when there is a message cancelation-impossible electronic device among the second electronic device 1 320-1 to the second electronic device N 320-N, the message server 330 may determine that message cancelation for the receiving electronic devices is impossible. In this case, when there is even one message cancelation-impossible electronic device among the receiving devices, it may be determined that message cancelation for the receiving electronic devices is impossible. According to another embodiment, when there is a message cancelation-possible electronic device among the receiving electronic devices, the message server 330 may determine that message cancelation for the receiving electronic devices is possible. In this case, when there is even one message cancelation-possible electronic device among the receiving electronic devices, it may be determined that message cancelation is possible.

Meanwhile, similarly to the receiving side, the message server 330 may also determine the possibility of message cancelation for each of the first electronic device 2 310-2 to the first electronic device N 310-N linked with the first electronic device 1 310-1 of the transmitting side via the N screen service. In determining the possibility of message cancelation for each of the first electronic device 2 310-2 to the first electronic device N 310-N of the transmitting side, the message server 330 may determine the possibility of message cancelation depending on whether each of the first electronic device 2 310-2 to the first electronic device N 310-N is supportive of cancelation or may determine the possibility of message cancelation depending on whether each of the first electronic device 2 310-2 to the first electronic device N 310-N is supportive of cancelation and is in the idle state.

According to one embodiment, when there is a message cancelation-impossible electronic device among the first electronic device 2 310-2 to the first electronic device N 310-N of the transmitting side, the message server 330 may determine that message cancelation for the transmitting electronic devices is impossible. In this case, when there is even one message cancelation-impossible electronic device among the transmitting electronic devices, it may be determined that message cancelation for the transmitting electronic devices is impossible. According to another embodiment, when there is a message cancelation-possible electronic device among the transmitting electronic devices, the message server 330 may determine that message cancelation for the transmitting electronic devices is possible. In this case, when there is even one message cancelation-possible electronic device among the transmitting electronic devices, it may be determined that message cancelation for the transmitting side is possible.

When it is determined that both message cancelation for the transmitting side and message cancelation for the receiving side are possible, the message server 330 may determine that message cancelation is possible. Otherwise, the message server 330 may determine that message cancelation is impossible. According to another embodiment, when it is determined that message cancelation for the receiving side is possible, the message server 330 may determine that message cancelation is possible. When it is determined that message cancelation for the receiving side is impossible, the message server 330 may determine that message cancelation is impossible.

When it is determined that message cancelation is impossible, the message server 330 may notify the first electronic device 1 310-1 of the transmitting side that cancelation is impossible.

When it is determined that message cancelation for the receiving side is possible, the message server 330 may transmit an UNDO message requesting the cancelation of a message to each of the second electronic device 1 320-1 to the second electronic device N 320-N of the receiving side in operations 406 and 408. When it is determined that message cancelation for the transmitting side is possible, the message server 330 may transmit an UNDO message requesting the cancelation of the transmission of a sent message to each of the first electronic device 2 310-2 to the first electronic device N 310-N of the transmitting side in operations 410 and 412. According to one embodiment, the message server 330 may transmit an UNDO message through a TCP or through a PUSH message to each of the second electronic device 1 320-1 to the second electronic device N 320-N of the receiving side. According to one embodiment, the UNDO message may include a Unique ID (UID) of a receiving electronic device, a chat room ID (Session ID), a transmitter ID (User ID), and a message ID (msID). Further, according to one embodiment, the message server 330 may transmit an UNDO message through a TCP or through a PUSH message to each of the first electronic device 2 310-2 to the first electronic device N 310-N of the transmitting side.

When the UNDO message requesting the cancelation of a message is received, each of the second electronic device 1 320-1 to the second electronic device N 320-N of the receiving side may cancel a received message in operations 414 and 416. According to one embodiment, each of the second electronic device 1 320-1 to the second electronic device N 320-N may determine whether a message to be canceled has been read. If the message to be canceled has not been read, each of the second electronic device 1 320-1 to the second electronic device N 320-N may process the message to be canceled not to be displayed and may delete the stored message to be canceled. If the message to be canceled has been read, each of the second electronic device 1 320-1 to the second electronic device N 320-N may perform a process such that a message indicating that the message is canceled is displayed instead of the message to be canceled and may delete the stored message to be canceled. When a message cancelation process is completed, each of the second electronic device 1 320-1 to the second electronic device N 320-N may transmit an UNDO ACK message to the message server 330 to indicate that the message is canceled in operations 418 and 420.

When the UNDO message requesting the cancelation of the transmission of a sent message is received, each of the first electronic device 2 310-2 to the first electronic device N 310-N of the transmitting side may cancel the transmission of a sent message in operations 422 and 424. According to one embodiment, each of the first electronic device 2 310-2 to the first electronic device N 310-N may delete a record of a sent message and may display a message indicating the cancelation of transmission. When the cancelation of transmission is completed, each of the first electronic device 2 310-2 to the first electronic device N 310-N may transmit an UNDO ACK message indicating that the transmission of a message is canceled to the message server 330 in operations 426 and 428. When a received message is canceled by each of the second electronic device 1 320-1 to the second electronic device N 320-N of the receiving side, the message server 330 may receive an UNDO ACK message from each of the second electronic device 1 320-1 to the second electronic device N 320-N. Also, when transmission is canceled by each of the first electronic device 2 310-2 to the first electronic device N 310-N of the transmitting side, the message server 330 may receive an UNDO ACK message from each of the first electronic device 2 310-2 to the first electronic device N 310-N.

When the UNDO ACK message is received from each of the second electronic device 1 320-1 to the second electronic device N 320-N, the message server 330 may determine that message cancelation is completed in operation 430. Here, when determining the completion of cancelation, it may be considered whether an UNDO ACK message is received according to the cancelation of transmission by each of the first electronic device 2 310-2 to the first electronic device N 310-N of the transmitting side.

When message cancelation is completed, the message server 330 may transmit an UNDO CONFIRM message indicating the completion of message cancelation to the first electronic device 1 310-1 of the transmitting side in operation 432. According to one embodiment, the UNDO CONFIRM message may include a Unique ID (UID) of a transmitting electronic device, a chat room ID (Session ID), a receiver ID (User ID), and a message ID (msID).

When the UNDO CONFIRM message is received, the first electronic device 1 310-1 may display information indicating a message cancelation notification in operation 434.

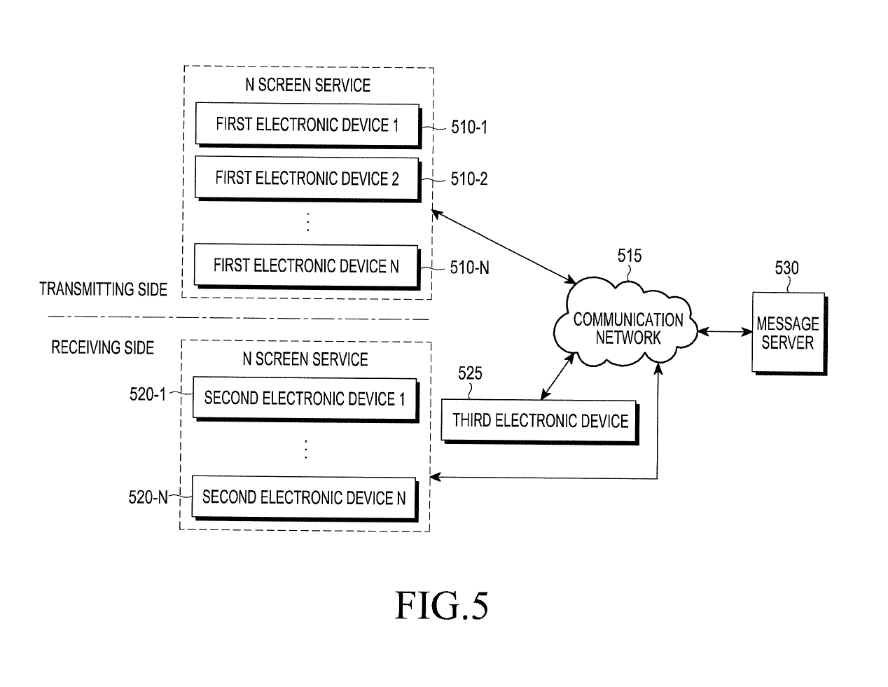

FIG. 5 is a schematic diagram of a message service system according to a third embodiment of the present invention. Referring to FIG. 5, any one of a first electronic device 1 510-1 to a first electronic device N 510-N that are linked using a first user account, any one of a second electronic device 1 520-1 to a second electronic device N 520-N that are linked using a second user account, and a third electronic device using a third account may each transmit and receive a message for a group chat between a user of the first user account, a user of the second user account, and a user of the third account using a message application.

When any one (hereinafter, assumed to be the first electronic device 1 510-1) of the first electronic device 1 510-1 to the first electronic device N 510-N transmits a message, the first electronic device 1 510-1 may request the cancelation of the transmitted message, and may display information indicating a message cancelation notification upon receiving a message indicating the completion of message cancelation.

Each of the first electronic device 2 510-2 to the first electronic device N 510-N linked to the first electronic device 1 510-1 using the first user account may receive a message transmitted by the first electronic device 1 510-1 and may receive an UNDO message requesting the cancelation of the transmission of a sent message. Each of the first electronic device 2 510-2 to the first electronic device N 510-N may receive an UNDO message through a TCP or may receive an UNDO message through a PUSH message. When an UNDO message is received, each of the first electronic device 2 510-2 to the first electronic device N 510-N may cancel the transmission of a sent message. According to one embodiment, each of the first electronic device 2 510-2 to the first electronic device N 510-N may delete a record of a sent message and may display a message indicating the cancelation of transmission.

Meanwhile, each of the second electronic device 1 520-1 to the second electronic device N 520-N and the third electronic device 525 of a receiving side may receive a message and may receive an UNDO message requesting the cancelation of a received message. According to one embodiment, when an UNDO message is received, each of the second electronic device 1 520-1 to the second electronic device N 520-N and the third electronic device 525 may cancel a received message. According to one embodiment, each of the second electronic device 1 520-1 to the second electronic device N 520-N and the third electronic device 525 may determine whether a message to be canceled has been read. When the message to be canceled has not been read, each of the second electronic device 1 520-1 to the second electronic device N 520-N and the third electronic device 525 may process the message to be canceled not to be displayed and may delete the stored message to be canceled. When the message to be canceled has been read, each of the second electronic device 1 520-1 to the second electronic device N 520-N and the third electronic device 525 may perform a process such that a message indicating that the message is canceled is displayed instead of the message to be canceled and may delete the stored message to be canceled. When a cancelation process is completed, each of the second electronic device 1 520-1 to the second electronic device N 520-N and the third electronic device 525 may transmit an UNDO ACK message to indicate that the message is canceled.

A message server 530 may receive a message cancelation request message requesting the cancelation of a message transmitted from the first electronic device 1 510-1. When the message cancelation request message is received, the message server 530 may determine whether it is possible to cancel the message.

According to one embodiment, the message server 530 may determine the possibility of message cancelation for each of the second electronic device 1 520-1 to the second electronic device N 520-N and the third electronic device 525 of the receiving side and the possibility of message cancelation for each of the first electronic device 2 510-2 to the first electronic device N 510-N linked with the first electronic device 1 510-1 of the transmitting side using the same account.

First, in determining the possibility of message cancelation for each of the second electronic device 1 520-1 to the second electronic device N 520-N and the third electronic device 525 of the receiving side, the message server 530 may determine the possibility of message cancelation depending on whether each of the second electronic device 1 520-1 to the second electronic device N 520-N and the third electronic device 525 is supportive of cancelation or may determine the possibility of message cancelation depending on whether each of the second electronic device 1 520-1 to the second electronic device N 520-N and the third electronic device 525 is supportive of cancelation and is in the idle state.

According to one embodiment, when determining the possibility of message cancelation depending on whether each of the second electronic device 1 520-1 to the second electronic device N 520-N and the third electronic device 525 is supportive of cancelation, the message server 530 may check whether each of the second electronic device 1 520-1 to the second electronic device N 520-N is a cancelation-supportive device or a cancelation-unsupportive device and may check whether the third electronic device 525 is a cancelation-supportive device or a cancelation-unsupportive device.

When there is a cancelation-unsupportive device among the second electronic device 1 520-1 to the second electronic device N 520-N and the third electronic device 525, the message server 530 may determine that message cancelation is impossible; when there is no cancelation-unsupportive device, the message server 530 may determine that message cancelation is possible. In this case, when there is even one cancelation-unsupportive electronic device among the second electronic device 1 520-1 to the second electronic device N 520-N and the third electronic device 525, the message server 530 may determine that message cancelation is impossible. Alternatively, when there is a cancelation-supportive device among the second electronic device 1 520-1 to the second electronic device N 520-N and the third electronic device 525, the message server 530 may determine that message cancelation is possible. When there is no cancelation-supportive device, the message server 530 may determine that message cancelation is impossible. In this case, when there is even one cancelation-supportive electronic device, the message server 530 may determine that message cancelation is possible.

According to another embodiment, when determining the possibility of message cancelation depending on whether each of the second electronic device 1 520-1 to the second electronic device N 520-N and the third electronic device 525 is supportive of cancelation and is in the idle state, the message server 530 may check whether each of the second electronic device 1 520-1 to the second electronic device N 520-N and the third electronic device 525 is a cancelation-supportive device and is in the idle state. The message server 530 may determine a cancelation-supportive electronic device as a message cancelation-possible electronic device. The message server 530 may determine an electronic device that is unsupportive of cancelation and is in the idle state as a message cancelation-possible electronic device, and may determine an electronic device that is unsupportive of cancelation and is not in the idle state as a message cancelation-impossible electronic device.

According to one embodiment, when there is a message cancelation-impossible electronic device among the second electronic device 1 520-1 to the second electronic device N 520-N and the third electronic device 525, the message server 530 may determine that message cancelation for the receiving electronic devices is impossible. In this case, when there is even one message cancelation-impossible electronic device among the receiving devices, it may be determined that message cancelation for the receiving electronic devices is impossible. According to another embodiment, when there is a message cancelation-possible electronic device among the receiving electronic devices, the message server 530 may determine that message cancelation for the receiving electronic devices is possible. In this case, when there is even one message cancelation-possible electronic device among the receiving electronic devices, it may be determined that message cancelation is possible.

Meanwhile, similarly to the receiving side, the message server 530 may also determine the possibility of message cancelation for each of the first electronic device 2 510-2 to the first electronic device N 510-N linked with the first electronic device 1 510-1 of the transmitting side using the N screen service. In determining the possibility of message cancelation for each of the first electronic device 2 510-2 to the first electronic device N 510-N of the transmitting side, the message server 530 may determine the possibility of message cancelation depending on whether each of the first electronic device 2 510-2 to the first electronic device N 510-N is supportive of cancelation or may determine the possibility of message cancelation depending on whether each of the first electronic device 2 510-2 to the first electronic device N 510-N is supportive of cancelation and is in the idle state.

According to one embodiment, when there is a message cancelation-impossible electronic device among the first electronic device 2 510-2 to the first electronic device N 510-N of the transmitting side, the message server 530 may determine that message cancelation for the transmitting electronic devices is impossible. In this case, when there is even one message cancelation-impossible electronic device among the transmitting electronic devices, it may be determined that message cancelation for the transmitting electronic devices is impossible. According to another embodiment, when there is a message cancelation-possible electronic device among the transmitting electronic devices, the message server 530 may determine that message cancelation for the transmitting electronic devices is possible. In this case, when there is even one message cancelation-possible electronic device among the transmitting electronic devices, it may be determined that message cancelation for the transmitting side is possible.

According to one embodiment, when it is determined that both message cancelation for the transmitting side and message cancelation for the receiving side are possible, the message server 530 may determine that message cancelation is possible. Otherwise, the message server 530 may determine that message cancelation is impossible. According to another embodiment, when it is determined that message cancelation for the receiving side is possible, the message server 530 may determine that message cancelation is possible. When it is determined that message cancelation for the receiving side is impossible, the message server 530 may determine that message cancelation is impossible.

When it is determined that message cancelation is impossible, the message server 530 may notify the first electronic device 1 510-1 of the transmitting side that cancelation is impossible.

When it is determined that message cancelation for the receiving side is possible, the message server 530 may transmit an UNDO message requesting the cancelation of a message to each of the second electronic device 1 520-1 to the second electronic device N 520-N and the third electronic device 525 of the receiving side. When it is determined that message cancelation for the transmitting side is possible, the message server 530 may transmit an UNDO message requesting the cancelation of transmission to each of the first electronic device 2 510-2 to the first electronic device N 510-N linked with the first electronic device 1 510-1 of the transmitting side using the same account. According to one embodiment, the UNDO message may include a Unique ID (UID) of a receiving electronic device, a chat room ID (Session ID), a transmitter ID (User ID), and a message ID (msID).

When a received message is canceled by each of the second electronic device 1 520-1 to the second electronic device N 520-N and the third electronic device 525 of the receiving side, the message server 530 may receive an UNDO ACK message from each of the second electronic device 1 520-1 to the second electronic device N 520-N and the third electronic device 525. Also, when transmission is canceled by each of the first electronic device 2 510-2 to the first electronic device N 510-N of the transmitting side, the message server 530 may receive an UNDO ACK message from each of the first electronic device 2 510-2 to the first electronic device N 510-N.

When the UNDO ACK message is received from each of the second electronic device 1 520-1 to the second electronic device N 520-N and the third electronic device 525, the message server 530 may determine that message cancelation is completed and may transmit an UNDO CONFIRM message indicating that the completion of message cancelation to the first electronic device 1 510-1 of the transmitting side. Here, when determining the completion of cancelation, it may be considered whether an UNDO ACK message is received according to the cancelation of transmission by each of the first electronic device 2 510-2 to the first electronic device N 510-N of the transmitting side.

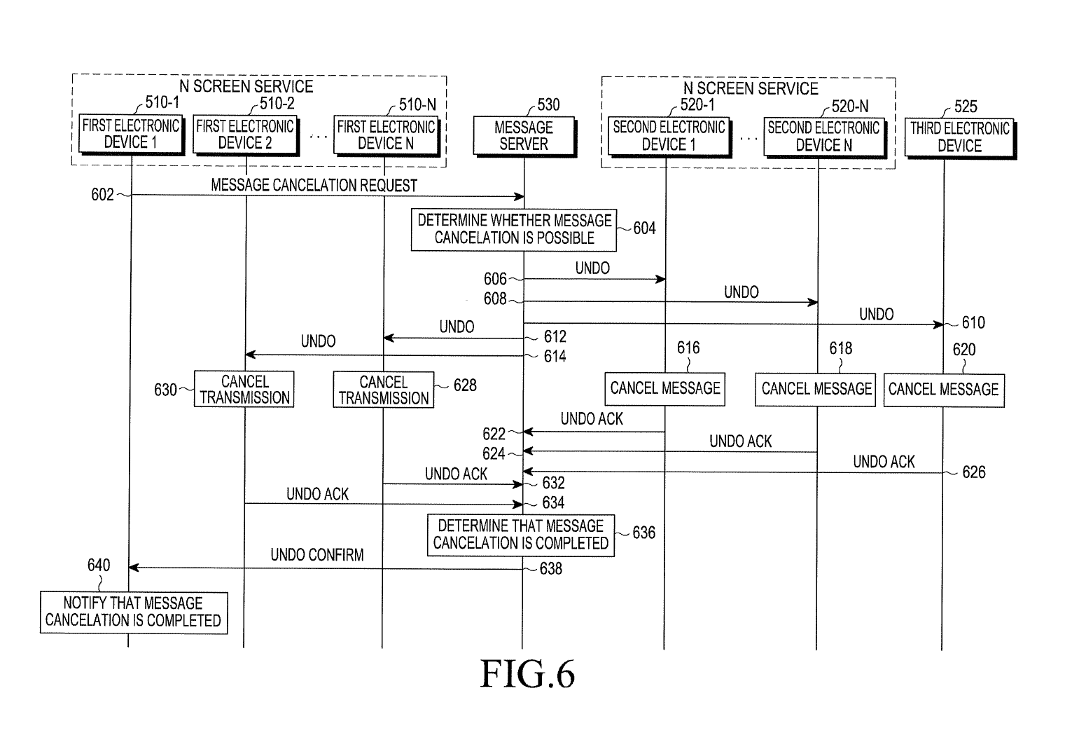

FIG. 6 is a flowchart illustrating message cancelation in the message service system according to the third embodiment of the present invention.

Referring to FIG. 6, any one of the first electronic device 1 510-1 to the first electronic device N 510-N of the transmitting side, for example, the first electronic device 1 510-1, may transmit a message cancelation request message for canceling a sent message to the message server 530 in operation 602. According to one embodiment, the message cancelation request message may include an ID of a message to be canceled.

When the message cancelation request message is received, the message server 530 may determine whether message cancelation is possible in operation 604.

According to one embodiment, the message server 530 may determine the possibility of message cancelation for each of the second electronic device 1 520-1 to the second electronic device N 520-N and the third electronic device 525 of the receiving side and the possibility of message cancelation for each of the first electronic device 2 510-2 to the first electronic device N 510-N linked with the first electronic device 1 510-1 of the transmitting side using the same account.

First, in determining the possibility of message cancelation for each of the second electronic device 1 520-1 to the second electronic device N 520-N and the third electronic device 525 of the receiving side, the message server 530 may determine the possibility of message cancelation depending on whether each of the second electronic device 1 520-1 to the second electronic device N 520-N and the third electronic device 525 is supportive of cancelation or may determine the possibility of message cancelation depending on whether each of the second electronic device 1 520-1 to the second electronic device N 520-N and the third electronic device 525 is supportive of cancelation and is in the idle state.

According to one embodiment, when determining the possibility of message cancelation depending on whether each of the second electronic device 1 520-1 to the second electronic device N 520-N and the third electronic device 525 is supportive of cancelation, the message server 530 may check whether each of the second electronic device 1 520-1 to the second electronic device N 520-N is a cancelation-supportive device or a cancelation-unsupportive device and may check whether the third electronic device 525 is a cancelation-supportive device or a cancelation-unsupportive device.

When there is a cancelation-unsupportive device among the second electronic device 1 520-1 to the second electronic device N 520-N and the third electronic device 525, the message server 530 may determine that message cancelation is impossible; when there is no cancelation-unsupportive device, the message server 530 may determine that message cancelation is possible. In this case, when there is even one cancelation-unsupportive electronic device among the second electronic device 1 520-1 to the second electronic device N 520-N and the third electronic device 525, the message server 530 may determine that message cancelation is impossible. Alternatively, when there is a cancelation-supportive device among the second electronic device 1 520-1 to the second electronic device N 520-N and the third electronic device 525, the message server 530 may determine that message cancelation is possible. When there is no cancelation-supportive device, the message server 530 may determine that message cancelation is impossible. In this case, when there is even one cancelation-supportive electronic device, the message server 530 may determine that message cancelation is possible.

According to another embodiment, when determining the possibility of message cancelation depending on whether each of the second electronic device 1 520-1 to the second electronic device N 520-N and the third electronic device 525 is supportive of cancelation and is in the idle state, the message server 530 may check whether each of the second electronic device 1 520-1 to the second electronic device N 520-N and the third electronic device 525 is a cancelation-supportive device and is in the idle state. The message server 530 may determine a cancelation-supportive electronic device as a message cancelation-possible electronic device. The message server 530 may determine an electronic device that is unsupportive of cancelation and is in the idle state as a message cancelation-possible electronic device, and may determine an electronic device that is unsupportive of cancelation and is not in the idle state as a message cancelation-impossible electronic device.

According to one embodiment, when there is a message cancelation-impossible electronic device among the second electronic device 1 520-1 to the second electronic device N 520-N and the third electronic device 525, the message server 530 may determine that message cancelation for the receiving electronic devices is impossible. In this case, when there is even one message cancelation-impossible electronic device among the receiving devices, it may be determined that message cancelation for the receiving electronic devices is impossible. According to another embodiment, when there is a message cancelation-possible electronic device among the receiving electronic devices, the message server 530 may determine that message cancelation for the receiving electronic devices is possible. In this case, when there is even one message cancelation-possible electronic device among the receiving electronic devices, it may be determined that message cancelation is possible.

Meanwhile, similarly to the receiving side, the message server 530 may also determine the possibility of message cancelation for each of the first electronic device 2 510-2 to the first electronic device N 510-N linked with the first electronic device 1 510-1 of the transmitting side using the first account. In determining the possibility of message cancelation for each of the first electronic device 2 510-2 to the first electronic device N 510-N of the transmitting side, the message server 530 may determine the possibility of message cancelation depending on whether each of the first electronic device 2 510-2 to the first electronic device N 510-N is supportive of cancelation or may determine the possibility of message cancelation depending on whether each of the first electronic device 2 510-2 to the first electronic device N 510-N is supportive of cancelation and is in the idle state.

According to one embodiment, when there is a message cancelation-impossible electronic device among the first electronic device 2 510-2 to the first electronic device N 510-N of the transmitting side, the message server 530 may determine that message cancelation for the transmitting electronic devices is impossible. In this case, when there is even one message cancelation-impossible electronic device among the transmitting electronic devices, it may be determined that message cancelation for the transmitting electronic devices is impossible. According to another embodiment, when there is a message cancelation-possible electronic device among the transmitting electronic devices, the message server 530 may determine that message cancelation for the transmitting electronic devices is possible. In this case, when there is even one message cancelation-possible electronic device among the transmitting electronic devices, it may be determined that message cancelation for the transmitting side is possible.

When it is determined that both message cancelation for the transmitting side and message cancelation for the receiving side are possible, the message server 530 may determine that message cancelation is possible. Otherwise, the message server 530 may determine that message cancelation is impossible. According to another embodiment, when it is determined that message cancelation for the receiving side is possible, the message server 530 may determine that message cancelation is possible. When it is determined that message cancelation for the receiving side is impossible, the message server 530 may determine that message cancelation is impossible.

When it is determined that message cancelation is impossible, the message server 530 may notify the first electronic device 1 510-1 of the transmitting side that cancelation is impossible.

When it is determined that message cancelation for the receiving electronic devices is possible, the message server 530 may transmit an UNDO message requesting the cancelation of a message to each of the second electronic device 1 520-1 to the second electronic device N 520-N and the third electronic device 525 of the receiving side in operations 606 to 610. When it is determined that message cancelation for the transmitting electronic devices is possible, the message server 530 may transmit an UNDO message requesting the cancelation of the transmission of a sent message to each of the first electronic device 2 510-2 to the first electronic device N 510-N of the transmitting side in operations 612 and 614. According to one embodiment, the message server 530 may transmit an UNDO message through a TCP or through a PUSH message to each of the second electronic device 1 520-1 to the second electronic device N 520-N and the third electronic device 525 of the receiving side. According to one embodiment, the UNDO message may include a Unique ID (UID) of a receiving electronic device, a chat room ID (Session ID), a transmitter ID (User ID), and a message ID (msID). Further, according to one embodiment, the message server 530 may transmit an UNDO message through a TCP or through a PUSH message to each of the first electronic device 2 510-2 to the first electronic device N 510-N of the transmitting side.

When the UNDO message requesting the cancelation of a message is received, each of the second electronic device 1 520-1 to the second electronic device N 520-N and the third electronic device 525 of the receiving side may cancel a received message in operations 616 and 620. According to one embodiment, each of the second electronic device 1 520-1 to the second electronic device N 520-N and the third electronic device 525 may determine whether a message to be canceled has been read. If the message to be canceled has not been read, each of the second electronic device 1 520-1 to the second electronic device N 520-N and the third electronic device 525 may process the message to be canceled not to be displayed and may delete the stored message to be canceled. If the message to be canceled has been read, each of the second electronic device 1 520-1 to the second electronic device N 520-N and the third electronic device 525 may perform a process such that a message indicating that the message is canceled is displayed instead of the message to be canceled and may delete the stored message to be canceled. When a message cancelation process is completed, each of the second electronic device 1 520-1 to the second electronic device N 520-N and the third electronic device 525 may transmit an UNDO ACK message to the message server 530 to indicate that the message is canceled in operations 622 and 626.

When the UNDO message requesting the cancelation of the transmission of a sent message is received, each of the first electronic device 2 510-2 to the first electronic device N 510-N of the transmitting side may cancel the transmission of a sent message in operations 628 and 630. According to one embodiment, each of the first electronic device 2 510-2 to the first electronic device N 510-N may delete a record of a sent message and may display a message indicating the cancelation of transmission. When the cancelation of transmission is completed, each of the first electronic device 2 510-2 to the first electronic device N 510-N may transmit an UNDO ACK message indicating that the transmission of a message is canceled to the message server 530 in operations 632 and 634. When a received message is canceled by each of the second electronic device 1 520-1 to the second electronic device N 520-N and the third electronic device 525 of the receiving side, the message server 530 may receive an UNDO ACK message from each of the second electronic device 1 520-1 to the second electronic device N 520-N and the third electronic device 525. Also, when transmission is canceled by each of the first electronic device 2 510-2 to the first electronic device N 510-N of the transmitting side, the message server 530 may receive an UNDO ACK message from each of the first electronic device 2 510-2 to the first electronic device N 510-N.

When the UNDO ACK message is received from each of the second electronic device 1 520-1 to the second electronic device N 520-N and the third electronic device 525, the message server 530 may determine that message cancelation is completed in operation 636. Here, when determining the completion of cancelation, it may be considered whether an UNDO ACK message is received according to the cancelation of transmission by each of the first electronic device 2 510-2 to the first electronic device N 510-N of the transmitting side.

When message cancelation is completed, the message server 530 may transmit an UNDO CONFIRM message indicating the completion of message cancelation to the first electronic device 1 510-1 of the transmitting side in operation 638. According to one embodiment, the UNDO CONFIRM message may include a Unique ID (UID) of a transmitting electronic device, a chat room ID (Session ID), a receiver ID (User ID), and a message ID (msID).

When the UNDO CONFIRM message is received, the first electronic device 1 510-1 may display information indicating a message cancelation notification in operation 640.

According to various embodiments of the present invention illustrated above, when a transmitting or receiving electronic device that exchanges messages is in an N screen service of being linked with a plurality of electronic devices using the same account, it is also possible to cancel a message to the electronic devices linked via the N screen service.

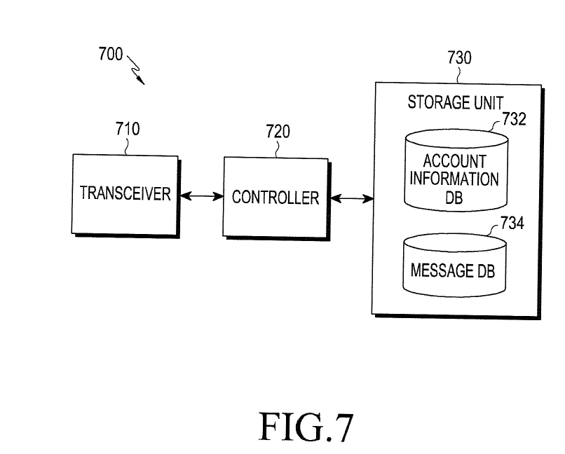

FIG. 7 is a diagram illustrating a configuration of a message server according to an embodiment of the present invention. Referring to FIG. 7, the message server 700 may include a transceiver 710, a controller 720, and a storage unit 730.

The transceiver 710 may transmit and receive messages necessary to cancel a message to and from at least one or more receiving electronic devices. For example, the transceiver 710 may receive a message cancelation request from any one of at least one or more transmitting electronic devices and may transmit an UNDO message for canceling a message to at least one or more receiving electronic devices. Also, the transceiver 710 may receive an UNDO ACK message indicating that a message is canceled from each of at least one or more receiving electronic devices or may receive an UNDO CONFIRM message indicating the completion of message cancelation for the at least one or more receiving electronic devices to a transmitting electronic device.

When a message cancelation request for a message transmitted to at least one or more receiving electronic devices is received from a transmitting electronic device, the controller 720 may determine the possibility of the cancelation of the message using user account information on each subscriber, electronic device information corresponding to user account information, information on an electronic device linked using the same user account information using user account information, and transmitted and received messages, which are stored in the storage unit 730, and may perform a message cancelation operation if the cancelation of the message is possible. In determining the possibility of the cancelation of the message, the controller 720 may determine the possibility of the cancelation of the message according to whether each of electronic devices corresponding to each user account is supportive of cancelation according to one embodiment, or may determine the possibility of the cancelation of the message according to whether each of electronic devices corresponding to each user account is supportive of cancelation and is in the idle state according to another embodiment.

The storage unit 730 may include an account information database (DB) 732 and a message DB 734. The account information DB may store user account information on each subscriber, electronic device information corresponding to user account information, and information on an electronic device linked using the same user account information. The message DB 734 may store information on transmitted and received messages.

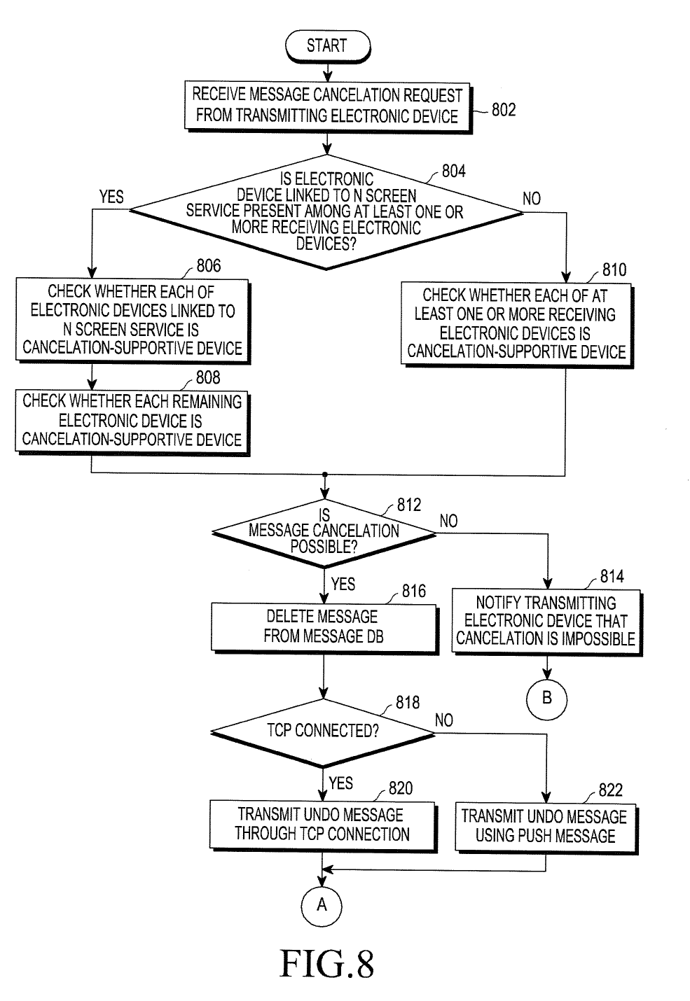

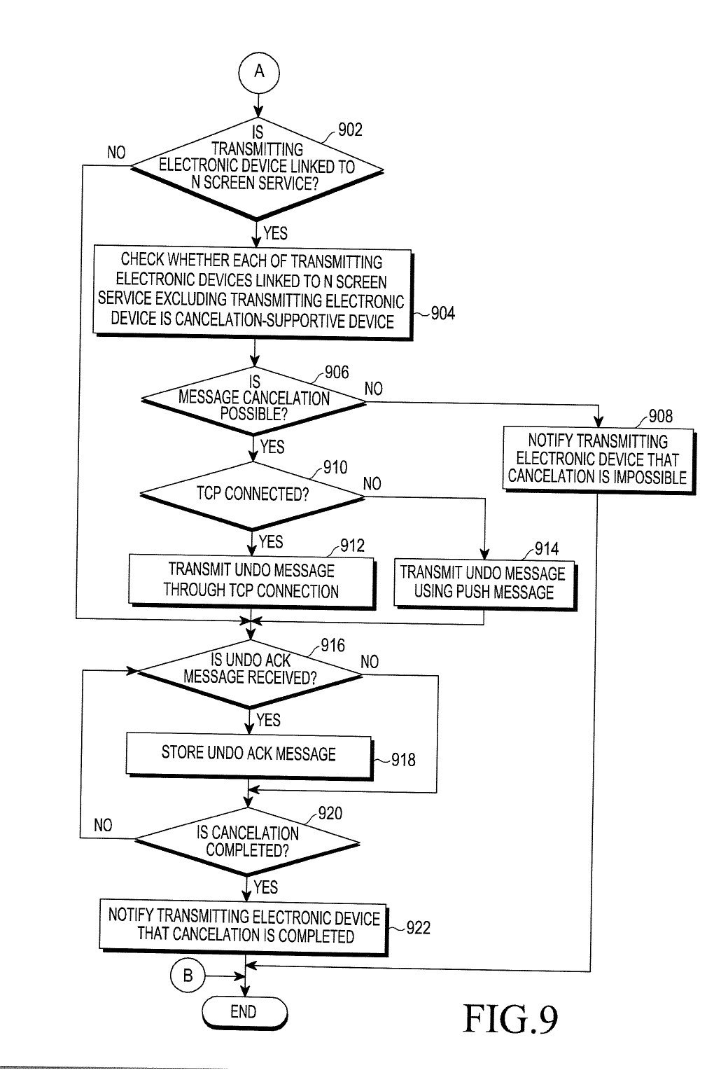

FIGS. 8 and 9 are flowcharts illustrating a message cancelation operation of a message server according to the first embodiment of the present invention. First, referring to FIG. 8, the message server 700 may receive a message cancelation request from a transmitting electronic device in operation 802. According to one embodiment, the message server 700 may receive a message cancelation request for a message transmitted to at least one or more receiving electronic devices from the transmitting electronic device.

When the message cancelation request is received, the message server 700 may determine whether there is a plurality of electronic devices linked using the same user account (hereinafter, referred to electronic devices linked to an N screen service) among the at least one or more receiving electronic devices in operation 804.

When there are electronic devices linked to the N screen service among the at least one or more receiving electronic devices, the message server 700 may check whether each of the electronic devices linked to the N screen service is a cancelation-supportive device in operation 806. Also, the message server 700 may check whether a remaining electronic device other than the electronic devices linked to the N screen service is a cancelation-supportive device in operation 808.

Meanwhile, when there is no electronic device linked to the N screen service among the at least one or more receiving electronic devices, the message server 700 may check whether each of the at least one or more receiving electronic devices is a cancelation-supportive device in operation 810.

After checking whether each of the at least one or more receiving electronic devices is a cancelation-supportive device, the message server 700 may determine whether message cancelation is possible in operation 812.

The message server 700 may determine that message cancelation for a receiving side is impossible when there is a cancelation-unsupportive electronic device among the at least one or more receiving electronic devices; and may determine that message cancelation for the receiving side is possible when there is no cancelation-unsupportive electronic device among the at least one or more receiving electronic devices.

When message cancelation for the receiving side is impossible, the message server 700 may notify the transmitting electronic device that message cancelation for the receiving side is impossible in operation 814 and may terminate the operation.

When message cancelation for the receiving side is possible, the message server 700 may: delete a message to be canceled from messages of the receiving side stored in the message DB 734 in operation 816; determine whether each of the at least one or more receiving electronic devices is TCP-connected in operation 818; and transmit an UNDO message via TCP connection in operation 820 when each of the at least one or more receiving electronic devices is TCP-connected, or may transmit an UNDO message using a PUSH message in operation 822 when each of the at least one or more receiving electronic devices is not TCP-connected. Here, when the UNDO message is received, each of the at least one or more receiving electronic devices may cancel the message.

Next, referring to FIG. 9, after transmitting the UNDO message to each of the at least one or more receiving electronic devices, the message server 700 may determine whether the transmitting electronic device is a device linked to the N screen service in operation 902.

When the transmitting electronic device is a device linked to the N screen service, the message server 700 may check whether each of the other transmitting electronic devices linked to the N service, excluding the transmitting electronic device, is a cancelation-supportive device in operation 904.

After checking whether each of the other transmitting electronic devices linked to the N service excluding the transmitting electronic device is a cancelation-supportive device, the message server 700 may determine whether message cancelation is possible in operation 906.

When there is a cancelation-unsupportive electronic device among the other transmitting electronic devices linked to the N service excluding the transmitting electronic device, the message server 700 may determine that message cancelation for a transmitting side is impossible, may notify the transmitting electronic device that message cancelation for the transmitting side is impossible in operation 908, and may terminate the operation.

When there is no cancelation-unsupportive electronic device among the other transmitting electronic devices linked to the N service excluding the transmitting electronic device, the message server 700 may: determine that message cancelation for the transmitting side is possible; determine whether each of the other transmitting electronic devices linked to the N service excluding the transmitting electronic device is TCP-connected in operation 910; and transmit an UNDO message for the cancelation of transmission via TCP connection in operation 912 when each of the other transmitting electronic devices linked to the N service, excluding the transmitting electronic device, is TCP-connected, or may transmit an UNDO message for the cancelation of transmission using a PUSH message in operation 914 when each of the other transmitting electronic devices linked to the N service, excluding the transmitting electronic device, is not TCP-connected. Here, when the UNDO message is received, each of the other transmitting electronic devices linked to the N service, excluding the transmitting electronic device, may cancel the transmission of a message.

The message server 700 may determine whether an UNDO ACK message is received in operation 916. The message server 700 may receive an UNDO ACK message when each of the at least one or more receiving electronic devices cancels the message. Also, the message server 700 may receive an UNDO ACK message when each of the other transmitting electronic devices linked to the N service excluding the transmitting electronic device cancels the transmission of a message.

The message server 700 may store at least one or more received UNDO ACK messages in operation 918 and may determine whether the cancelation of the message is completed in operation 920. When an UNDO ACK message is received from all of the at least one or more receiving electronic devices, the message server 700 may determine that the cancelation of the message is completed. Here, when determining the completion of cancelation, it may be considered whether an UNDO ACK message is received according to the cancelation of transmission by each of the other transmitting electronic devices linked to the N service excluding the transmitting electronic device.

When the cancelation of the message is completed, the message server 700 may notify the transmitting electronic device of the completion of cancelation in operation 922. For example, the message server 700 may transmit an UNDO CONFIRM message indicating the completion of message cancelation to the transmitting electronic device. According to one embodiment, the UNDO CONFIRM message may include a Unique ID (UID) of a transmitting electronic device, a chat room ID (Session ID), a receiver ID (User ID), and a message ID (msID).

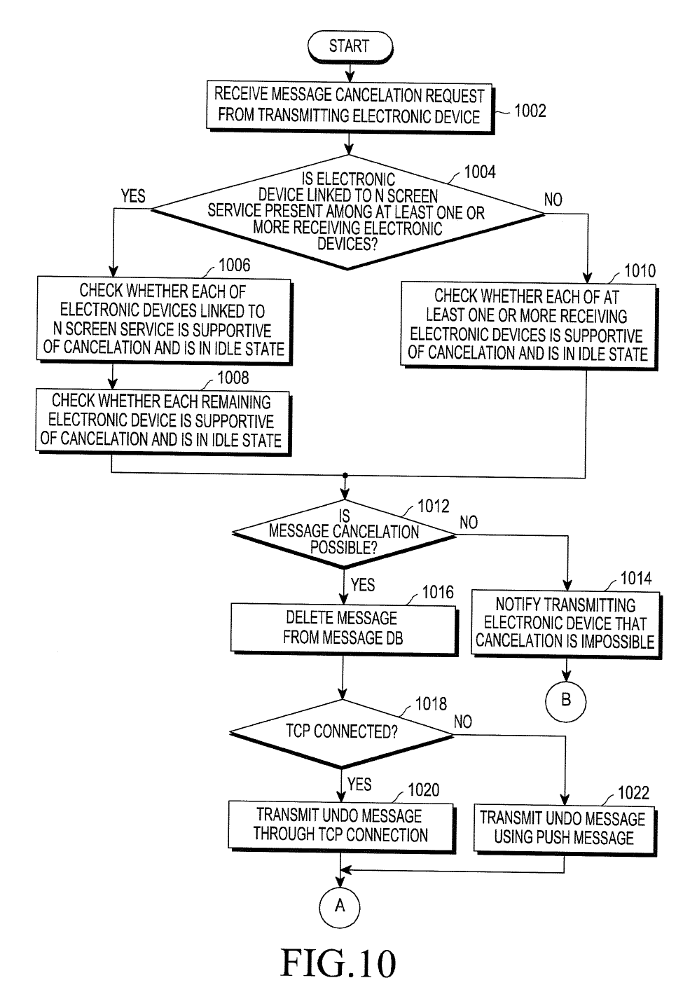

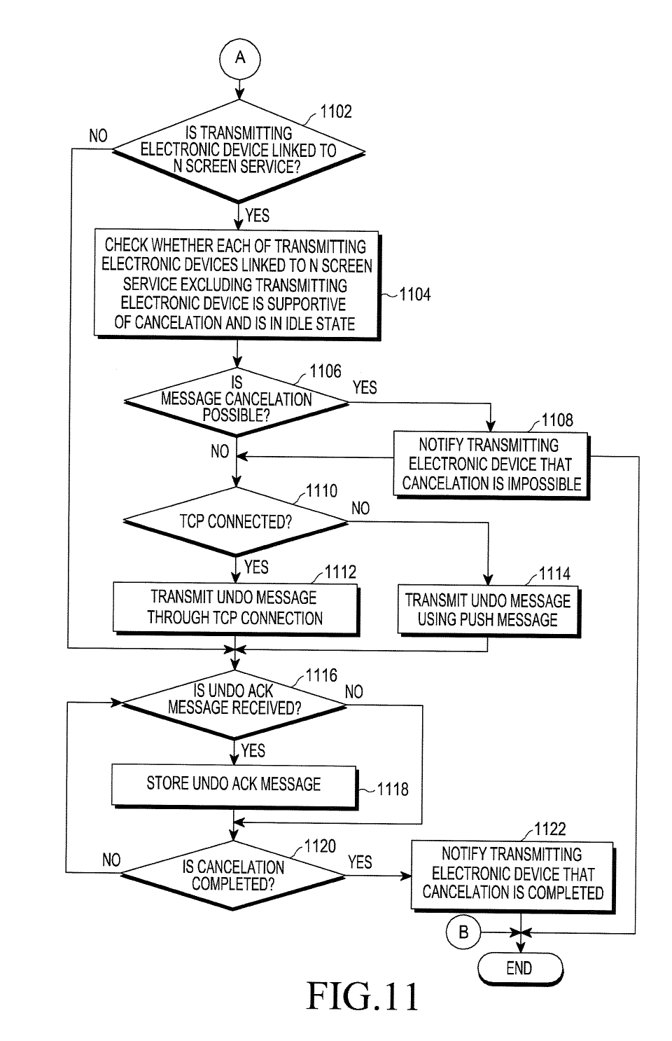

FIGS. 10 and 11 are flowcharts illustrating a message cancelation operation of a message server according to the second embodiment of the present invention. First, referring to FIG. 10, the message server 700 may receive a message cancelation request from a transmitting electronic device in operation 1002. According to one embodiment, the message server 700 may receive a message cancelation request for a message transmitted to at least one or more receiving electronic devices from the transmitting electronic device.

When the message cancelation request is received, the message server 700 may determine whether there is an electronic device linked to an N screen service among the at least one or more receiving electronic devices in operation 1004.

When there is an electronic device linked to the N screen service among the at least one or more receiving electronic devices, the message server 700 may check whether each of the electronic devices linked to the N screen service is a cancelation-supportive device and is in the idle state in operation 1006. Also, the message server 700 may check a remaining electronic device other than the electronic devices linked to the N screen service is a cancelation-supportive device and is in the idle state in operation 1008.

Meanwhile, when there is no electronic device linked to the N screen service among the at least one or more receiving electronic devices, the message server 700 may check whether each of the at least one or more receiving electronic devices is a cancelation-supportive device and is in the idle state in operation 1010.

After checking whether each of the at least one or more receiving electronic devices is a cancelation-supportive device and is in the idle state, the message server 700 may determine whether message cancelation is possible in operation 1012. According to one embodiment, the message server 700 may determine whether there is an electronic device that is unsupportive of cancelation and is not in the idle state among the at least one or more receiving electronic devices. Here, a cancelation-supportive electronic device and an electronic device that is unsupportive of cancelation but is in the idle state may be determined as a cancelation-possible electronic device, while an electronic device that is unsupportive of cancelation and is not in the idle state may be determined as a cancelation-impossible electronic device. The message server 700 may determine that message cancelation for a receiving side is possible when there is no electronic device that is unsupportive of cancelation and is not in the idle state among the at least one or more receiving electronic devices, and may determine that message cancelation for the receiving side is impossible when there is an electronic device that is unsupportive of cancelation and is not in the idle state among the at least one or more receiving electronic devices.

When message cancelation is impossible, the message server 700 may notify the transmitting electronic device that message cancelation is impossible in operation 1014 and may terminate the operation.

When message cancelation for the receiving side is possible, the message server 700 may: delete a message to be canceled, which is stored in the message DB 734, in operation 1016; determine whether each of the at least one or more receiving electronic devices is TCP-connected in operation 1018; and transmit an UNDO message via TCP connection in operation 1020 when each of the at least one or more receiving electronic devices is TCP-connected, or may transmit an UNDO message using a PUSH message in operation 1022 when each of the at least one or more receiving electronic devices is not TCP-connected. Here, when the UNDO message is received, each of the at least one or more receiving electronic devices may cancel the message.

Next, referring to FIG. 11, after transmitting the UNDO message to each of the at least one or more receiving electronic devices, the message server 700 may determine whether the transmitting electronic device is a device linked to the N screen service in operation 1102.

When the transmitting electronic device is a device linked to the N screen service, the message server 700 may check whether each of the other transmitting electronic devices linked to the N service, excluding the transmitting electronic device, is a cancelation-supportive device and is in the idle state in operation 1104.

After checking whether each of the other transmitting electronic devices linked to the N service, excluding the transmitting electronic device, is a cancelation-supportive device and is in the idle state, the message server 700 may determine whether message cancelation is possible in operation 1006. According to one embodiment, when there is an electronic device that is unsupportive of cancelation and is not in the idle state among the other transmitting electronic devices linked to the N service excluding the transmitting electronic device, the message server 700 may determine that message cancelation for a transmitting side is impossible, may notify the transmitting electronic device that message cancelation is impossible in operation 1108, and may terminate the operation.

When there is no electronic device that is unsupportive of cancelation and is in the idle state among the other transmitting electronic devices linked to the N service excluding the transmitting electronic device, the message server 700 may: determine that message cancelation for the transmitting side is possible; determine whether each of the other transmitting electronic devices linked to the N service excluding the transmitting electronic device is TCP-connected in operation 1110; and transmit an UNDO message for the cancelation of transmission via TCP connection in operation 1112 when each of the other transmitting electronic devices linked to the N service, excluding the transmitting electronic device, is TCP-connected, or may transmit an UNDO message for the cancelation of transmission using a PUSH message in operation 1114 when each of the other transmitting electronic devices linked to the N service excluding the transmitting electronic device is not TCP-connected. Here, when the UNDO message is received, each of the other transmitting electronic devices linked to the N service, excluding the transmitting electronic device, may cancel the transmission of a message.

The message server 700 may determine whether an UNDO ACK message is received in operation 1116. The message server 700 may receive an UNDO ACK message when each of the at least one or more receiving electronic devices cancels the message. Also, the message server 700 may receive an UNDO ACK message when each of the other transmitting electronic devices linked to the N service excluding the transmitting electronic device cancels the transmission of a message.

The message server 700 may store at least one or more received UNDO ACK messages in operation 1118 and may determine whether the cancelation of the message is completed in operation 1120. When an UNDO ACK message is received from all of the at least one or more receiving electronic devices, the message server 700 may determine that the cancelation of the message is completed. Here, when determining the completion of cancelation, it may be considered whether an UNDO ACK message is received according to the cancelation of transmission by each of the other transmitting electronic devices linked to the N service excluding the transmitting electronic device.

When the cancelation of the message is completed, the message server 700 may notify the transmitting electronic device of the completion of cancelation in operation 1122. For example, the message server 700 may transmit an UNDO CONFIRM message indicating the completion of message cancelation to the transmitting electronic device. According to one embodiment, the UNDO CONFIRM message may include a Unique ID (UID) of a transmitting electronic device, a chat room ID (Session ID), a receiver ID (User ID), and a message ID (msID).

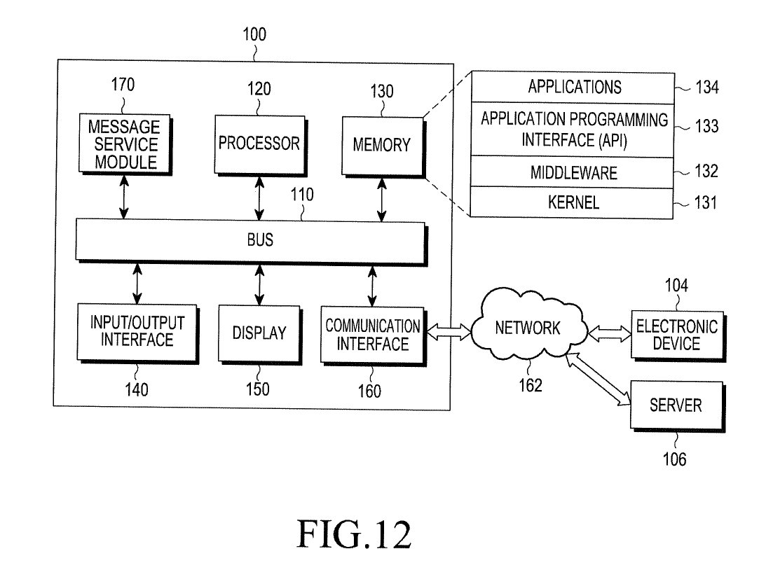

FIG. 12 illustrates a network environment including an electronic device according to various embodiments of the present invention. Referring to FIG. 12, the electronic device 100 may include a bus 110, a processor 120, a memory 130, an input/output interface 140, a display 150, a communication interface 160, and a message service module 170.

The bus 110 may be a circuit that connects the foregoing components to each other and delivers communications (for example, control messages) between the foregoing components.

The processor 120 may: receive a command from other components (for example, the memory 130, the input/output interface 140, the display 150, the communication interface 160, or the message service module 170), for example, through the bus 110; decode the received command; and perform an operation or data processing according to the decoded command.

The memory 130 may store commands or data received from the processor 120 or other components (for example, the input/output interface 140, the display 150, the communication interface 160, the message service module 170, or the like) or generated by the processor 120 or other components. The memory 130 may include programming modules, such as a kernel 131, a middleware 132, an application programming interface (API) 133, or an application 134. The foregoing programming modules may be configured with software, firmware, hardware, or a combination of at least two thereof.

The kernel 131 may control or manage system resources (for example, the bus 110, the processor 120, the memory 130, or the like) used to perform an operation or function implemented in other programming modules, for example, the middleware 132, the API 133, or the application 134. Further, the kernel 131 may provide an interface that allows the middleware 132, the API 133, or the application 134 to access an individual component of the electronic device 100 to thereby control or manage the component.

The middleware 132 may serve as a relay so that the API 133 or the application 134 communicates with the kernel 131 to exchange data. Further, regarding requests for operations received from the application 134, the middleware 132 may perform control (for example, scheduling or load balancing) of requests for operations, for example, using a method of assigning at least one application of the application 134 a priority for using a system resource (for example, the bus 110, the processor 120, the memory 130, or the like) of the electronic device 100.

The API 133 is an interface for the application 134 to control a function provided from the kernel 131 or the middleware 132 and may include, for example, at least one interface or function (for example, a command) for file control, window control, image processing, or text control.

According to various embodiments, the application 134 may include a messenger application, an SMS/MMS application, an email application, a calendar application, an alarm application, a health care application (for example, an application for measuring exercising or blood sugar), an environmental data application (for example, an application for providing atmospheric pressure, humidity, or temperature data), or the like. The application 134 may include applications relating to message transmission and reception and information exchange between the electronic device 100 and an external electronic device (for example, an electronic device 104). An application relating to information exchange may include, for example, a notification relay application for relaying specific information to the external electronic device or a device management application for managing the external electronic device. According to one embodiment, the application 134 may further include a social network service application and a content service application.

For example, the notification relay application may include a function of relaying notification information, which is generated in another application (for example, the SMS/MMS application, the email application, the health care application, the environmental data application, or the like) of the electronic device 100, to the external electronic device (for example, the electronic device 104). Additionally or alternatively, the notification relay application may receive notification information, for example, from the external electronic device (for example, the electronic device 104), and may provide the notification information to the user. The device management application may manage (for example, install, delete, or update), for example, at least some functions (for example, a function of turning on/turning off the external electronic device itself (or some components) or adjusting the brightness (or resolution) of a display) of the external electronic device (for example, the electronic device 104) communicating with the electronic device 100, an application operating in the external electronic device, or a service (for example, a call service or message service) provided by the external electronic device.

According to various embodiments, the application 134 may include an application assigned according to an attribute (for example, an electronic device type) of the external electronic device (for example, the electronic device 104). For example, when the external electronic device is an MP3 player, the application 134 may include an application relating to music playback. Similarly, when the external electronic device is a mobile medical device, the application 134 may include an application relating to health care. According to one embodiment, the application 134 may include at least one of an application assigned to the electronic device 100 and an application received from the external electronic device (for example, a server 106 or the electronic device 104).

The input/output interface 140 may transmit a command or data, which is input from a user through an input/output device (for example, a sensor, a keyboard, or a touch screen), to the processor 120, the memory 130, the communication interface 160, or the message service module 170, for example, through the bus 110. For example, the input/output interface 140 may provide, to the processor 120, data on a touch input by the user through the touch screen. Further, the input/output interface 140 may output, through the input/output device (for example, a speaker or display), a command or data that is received from the processor 120, the memory 130, the communication interface 160, or the message service module 170, for example, through the bus 110. For example, the input/output interface 140 may output audio data, which is processed by the processor 120, to the user through the speaker.

The display 150 may display various types of information (for example, multimedia data, text data, or the like) for the user.

The communication interface 160 may connect communication between the electronic device 100 and an external device (for example, the electronic device 104 or server 106). For example, the communication interface 160 may be connected to a network 162 via wireless communication or wire-based communication to communicate with the external device. The wireless communication may include at least one of, for example, Wireless Fidelity (Wi-Fi), Bluetooth (BT), Near Field Communication (NFC), a Global Positioning System (GPS), and cellular communication (for example, LTE, LTE-A, CDMA, WCDMA, UMTS, WiBro, GSM, or the like). The wire-based communication may include at least one of, for example, Universal Serial Bus (USB), High Definition Multimedia Interface (HDMI), Recommended Standard 232 (RS-232), and Plain Old Telephone Service (POTS).

According to one embodiment, the network 162 may be a telecommunications network. The telecommunications network may include at least one of a computer network, the Internet, the Internet of things, and a telephone network. According to one embodiment, a protocol for communication between the electronic device 100 and the external device (for example, a transport layer protocol, data link layer protocol or physical layer protocol) may be supported by at least one of the application 134, the API 133, the middleware 132, the kernel 131, and the communication interface 160.

The message service module 170 may process at least part of information acquired from other components (for example, the processor 120, the memory 130, the input/output interface 140, the communication interface 160, or the like) and may provide the processed information for the user using various methods. For example, the message service module 170 may process display message service data relayed from the communication interface 160 using the processor 120 or independently of the processor 120, thereby displaying a received message on the display 150 or outputting audio data corresponding to the received message through the input/output interface 140. That is, the message service module 170 may receive message service data requested by the user and may process the received message service data, thereby displaying a requested message service screen for the user.

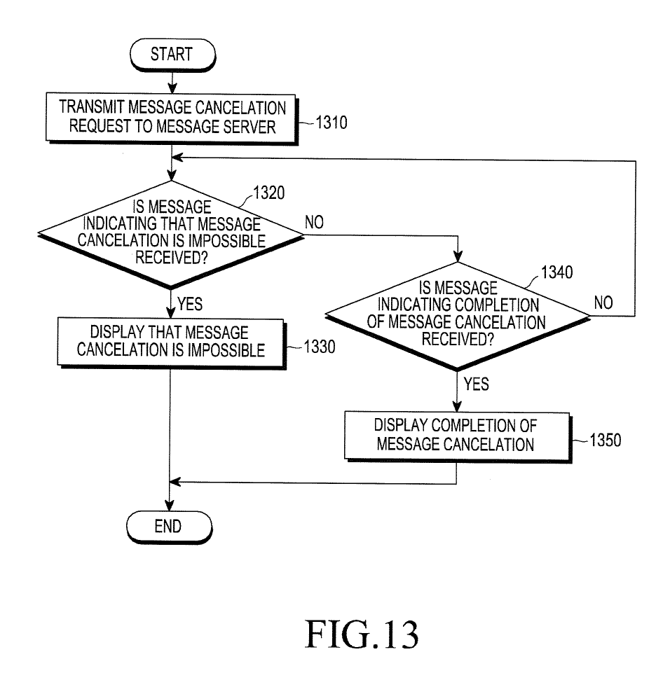

FIG. 13 is a flowchart illustrating a message cancelation request operation of an electronic device according to an embodiment of the present invention. Referring to FIG. 13, the electronic device 100 may transmit a message cancelation request to a message server 700 according to a message cancelation request transmitted from a user when a message is transmitted to at least one or more receiving electronic devices. The message server 700 may transmit an UNDO message for message cancelation to the at least one or more receiving electronic devices according to the message cancelation request from the electronic device 100. When an UNDO ACK message indicating the completion of message cancelation is received from the at least one or more receiving electronic devices, the message server 700 may notify the electronic device 100 that message cancelation is completed. When it is impossible for the at least one or more receiving electronic devices to cancel the message, the message server 700 may transmit a message indicating that message cancelation is impossible to the electronic device 100.

The electronic device 100 may determine whether the message indicating that message cancelation is impossible is received from the message server 700 in operation 1320 and may determine whether a message indicating the completion of message cancelation is received from the message server 700 in operation 1340.

When the message indicating that message cancelation is impossible is received, the electronic device 100 may display a message indicating that message cancelation is impossible in operation 1330. When the message indicating the completion of message cancelation is received, the electronic device 100 may display the completion of message cancelation in operation 1350.

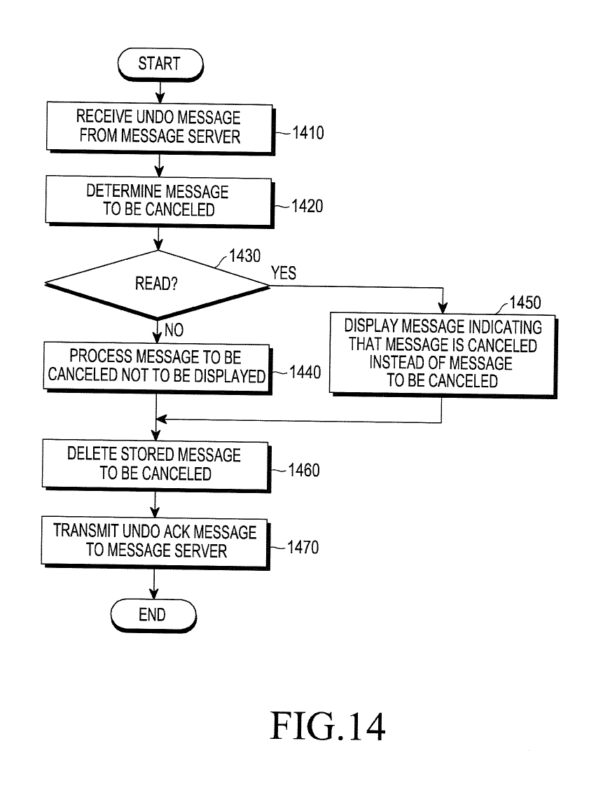

FIG. 14 is a flowchart illustrating a message cancelation operation of an electronic device according to an embodiment of the present invention. Referring to FIG. 14, the electronic device 100 may receive an UNDO message for the cancelation of a received message from a message server 700 in operation 1410. According to one embodiment, the electronic device 100 may receive an UNDO message through TCP communication when TCP communication is connected; and may receive an UNDO message through a PUSH message when TCP communication is not connected. According to one embodiment, the UNDO message may include a Unique ID (UID) of the electronic device 100, a chat room ID (Session ID), a transmitter ID (User ID), and a message ID (msID).

The electronic device 100 may determine a message to be canceled in operation 1420. According to one embodiment, the electronic device 100 may determine a message to be canceled using a chat room ID and a message ID included in the UNDO message.

The electronic device 100 may determine whether the message to be canceled has been read in operation 1430. When the message to be canceled has not been read, the electronic device 100 may process the message, which is to be canceled, not to be displayed on a chat window in operation 1440. When the message to be canceled has been read, the electronic device 100 may display a message indicating that the message is canceled, instead of the message to be canceled in the chat window, in operation 1450.

The electronic device 100 may delete the message to be canceled, which is stored in the memory, in operation 1460. The electronic device 100 may transmit an UNDO ACK message indicating the completion of message cancelation to the message server 700 in operation 1470.

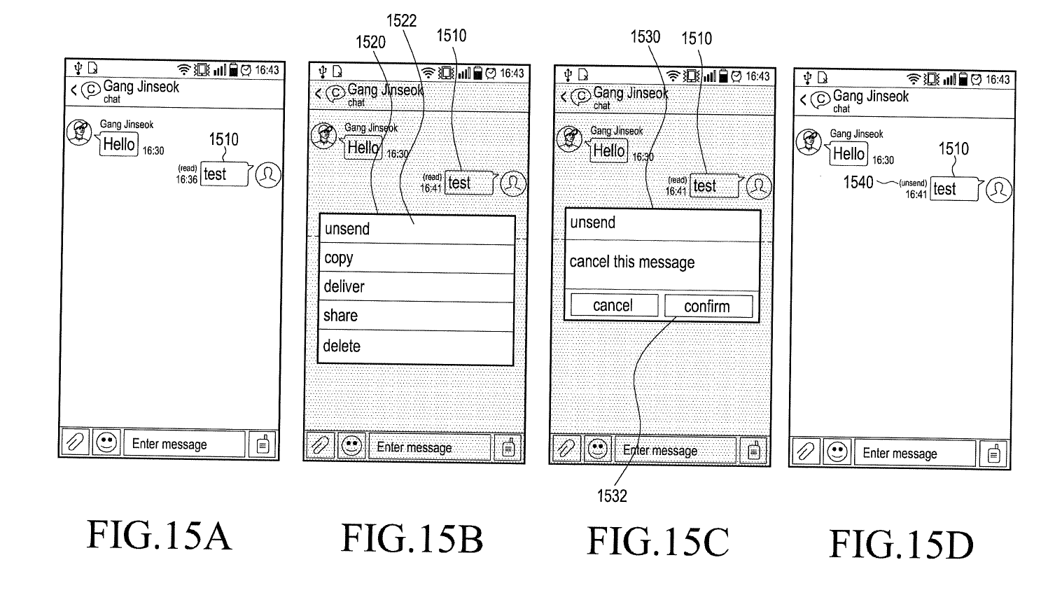

FIG. 15 illustrates a user interface screen displayed when a message cancelation request is made in an electronic device according to an embodiment of the present invention.

Referring to FIG. 15, the electronic device 100 may transmit a message of a test 1510 in a chat room illustrated in (a) of FIG. 15. The electronic device 100 may display, on the display 150, a menu 1520 for a user of the transmitted message of the test 1510 to select a message cancelation request as illustrated in (b) of FIG. 15. The menu 1520 may include an unsend item 1522 to request message cancelation. When the unsend item 1522 is selected by the user, the electronic device 100 may display an unsend confirm menu 1530 as illustrated in (c) of FIG. 15. When the user selects a confirm 1532 on the unsend confirm menu 1530, the electronic device 100 may transmit a message cancelation request message, and may display information 1540 indicating that the transmitted message of the test 1510 has been canceled as illustrated in (d) of FIG. 15.

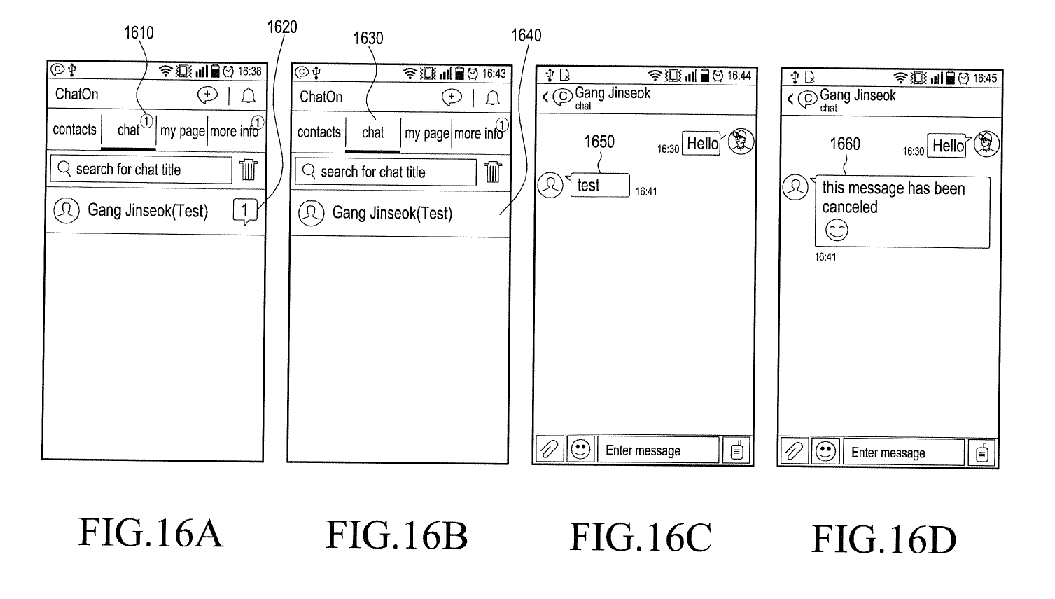

FIG. 16 illustrates a user interface screen displayed when a message is canceled in an electronic device according to an embodiment of the present invention.

Referring to FIG. 16, when there is an unread message among received messages in a chat room, the electronic device 100 may display badges 1610 and 1620 indicating that there is an unread message as illustrated in (a) of FIG. 16. When an UNDO message requesting message cancelation is received and a message to be canceled has not been read, the electronic device 100 may allow the badges 1610 and 1620 indicating that there is an unread message not to be displayed as illustrated with reference numbers 1630 and 1640 in (b) of FIG. 16.

Meanwhile, when the message to be canceled has been read, the electronic device 100 may process a read message of test 1650 not to be displayed on a chat window as illustrated in (c) of FIG. 16 and may display a message indicating that the message is canceled (that is, this message has been canceled 1660), instead of the message to be canceled as illustrated in (d) of FIG. 16.

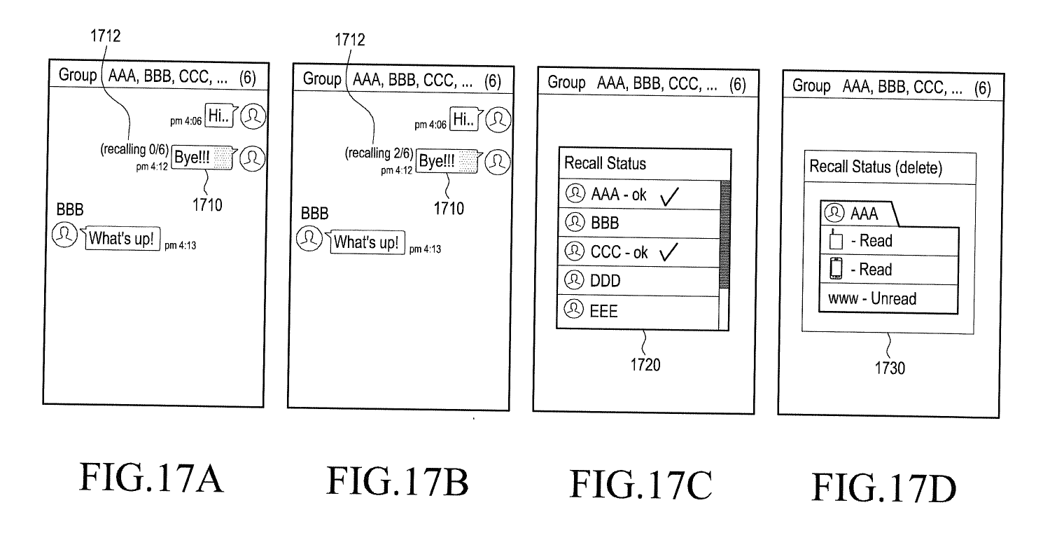

FIG. 17 illustrates a user interface screen displayed when a message cancelation request is made during a group chat in an electronic device according to an embodiment of the present invention.

Referring to FIG. 17, when it is requested to cancel a transmitted message, for example, Bye!!! 1710, in a group chat room, the electronic device 100 may display cancelation status information, for example, (recalling 0/6) 1712, indicating the status of the cancelation of a transmitted message from a recipient belonging to the group chat room as illustrated in (a) of FIG. 17. For example, (recalling 0/6) may indicate that the message has been canceled for none of six recipients belonging to the group chat room. When the message is canceled for a recipient, the electronic device 100 may update the cancelation status information indicating the status of the cancelation of the transmitted message from a recipient as illustrated in (b) of FIG. 17. (recalling 2/6) may indicate that the message has been canceled for two of the six recipients in the group chat room. The electronic device 100 may display information 1720 on a recipient for which the message has been canceled as illustrated in (c) of FIG. 17. For example, AAA and CCC may be recipients for which the message has been canceled, and the others may be recipients for which the message has not been canceled. Further, the electronic device 100 may display information 1730 indicating that each recipient has read the canceled message as illustrated in (d) of FIG. 17. For example, information indicating whether recipient AAA has read the canceled message may include information indicating that the received message has been canceled through three electronic devices linked to an N screen, the received message has been read in two of the three electronic devices, and the received message has not been read in the remaining one electronic device.

According to various embodiments of the present invention mentioned above, it is possible to cancel a message even while a transmitter or a recipient that exchanges messages is in an N screen service. Further, according to various embodiments of the present invention, it is possible to cancel a message even when a recipient has read the message, which is convenient. In addition, according to various embodiments of the present invention, even when there is a plurality of recipients that have received a message, as in a group chat room, and there is a recipient that has read the message among the recipients, it is possible for each of the recipients to cancel the message and it is possible to indicate a message cancelation status of each of the recipients, which is convenient.

The operations according to the various embodiments of the present invention may be in a form of program instructions executed through various computer means to be recorded in a computer readable medium. The computer readable medium may include a program command, a data file, a data structure, and the like independently or in combination. The program instructions recorded in the medium may be specially designed and configured for the present invention, or may be known to and usable by those skilled in the field of computer software.

It will be understood that the message service method according to various embodiments of the present invention may be implemented in the form of hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It can be also appreciated that the software may be stored in a machine (for example, a computer)-readable storage medium. It can also be noted that the message service method according to the present invention may be implemented by a computer or an electronic device including a memory and a controller, and the memory is an example of a machine-readable storage medium suitable for storing a program or programs including instructions that implement embodiments of the present invention. Therefore, the present invention may include a program including a code for implementing the apparatus or the method defined in the appended claims of the present specification and a machine (computer, etc.)-readable storage medium for storing the program. Furthermore, such a program may be electronically transferred through an arbitrary medium such as a communication signal transferred through a wired or wireless connection, and the present invention may appropriately include equivalents thereof.

Furthermore, the electronic device according to the embodiments of the present invention may receive and store the program from a program providing device connected thereto in a wired or wireless manner. The program providing device may include a memory that stores a program including instructions for performing the message service method according to various embodiments of the present invention, a communication unit that performs wired or wireless communication with the electronic device, and a controller that controls the corresponding program to be transmitted through the communication unit at the request of the electronic device or automatically.

1. A message service method comprising:
receiving, from a transmission terminal, a cancelation request for canceling a transmission message transmitted to at least one or more reception terminals;
determining whether it is possible to cancel the transmission message for each of the at least one or more reception terminals; and
transmitting a transmission message cancelation command signal to a reception terminal for which it is possible to cancel the transmission message among the at least one or more reception terminals,
wherein the at least one or more reception terminals comprise a plurality of terminals associated with a same user account.

2. The message service method as claimed in claim 1, further comprising:
confirming whether cancelation of the transmission message is completed for each of the at least one or more reception terminals; and
transmitting a cancelation completion signal to the transmission terminal upon confirmation.

3. The message service method as claimed in claim 2, wherein the confirming comprises:
receiving a cancelation confirmation signal from each of the at least one or more reception terminals; and
determining whether a cancelation confirmation signal is received from all of the at least one or more reception terminals to which the transmission message cancelation command signal is transmitted.

4. The message service method as claimed in claim 3, wherein the cancelation command signal is a form of an UNDO message, the UNDO message comprises a reception terminal ID (Unique ID (UID)), a chat room ID (Session ID), a transmission terminal ID (User ID), and a message ID (msID), the cancelation completion signal is a form of an UNDO CONFIRM message, and the UNDO CONFIRM message comprises a transmission terminal ID (Unique ID (UID)), a chat room ID (Session ID), a reception terminal ID (User ID), and a message ID (msID).

5. The message service method as claimed in claim 1, wherein the transmission terminal is one of the plurality of terminals associated with the same user account.

6. The message service method as claimed in claim 1, wherein the determining of whether it is possible to cancel the transmission message for each of the at least one or more reception terminals comprises:
checking whether each of the at least one or more reception terminals is supportive of message cancelation; and
determining that it is possible to cancel the message for a reception terminal that is supportive of message cancelation among the at least one or more reception terminals as a result of checking.

7. The message service method as claimed in claim 1, wherein the determining of whether it is possible to cancel the transmission message for each of the at least one or more reception terminals comprises:
checking whether each of the at least one or more reception terminals is supportive of message cancelation and is in an idle state; and
determining that it is possible to cancel the message for a reception terminal that is supportive of message cancelation and a reception terminal that is unsupportive of message cancelation and is in the idle state among the at least one or more reception terminals as a result of checking.

8. The message service method as claimed in claim 1, further comprising canceling, by the reception terminal for which it is possible to cancel the transmission message, a received message according to the transmission message cancelation command signal.

9. A message server comprising:
a transceiver that receives, from a transmission terminal, a cancelation request for canceling a transmission message transmitted to at least one or more reception terminals; and
a controller that controls to determine whether it is possible to cancel the transmission message for each of the at least one or more reception terminals and to transmit a transmission message cancelation command signal to a reception terminal for which it is possible to cancel the transmission message among the at least one or more reception terminals,
wherein the at least one or more reception terminals comprise a plurality of terminals associated with a same user account.

10. The message server as claimed in claim 9, wherein the controller confirms whether cancelation of the transmission message is completed for each of the at least one or more reception terminals, and transmits a cancelation completion signal to the transmission terminal upon confirmation.

11. The message server as claimed in claim 10, wherein when a cancelation confirmation signal is received from each of the at least one or more reception terminals, the controller determines whether a cancelation confirmation signal is received from all of the at least one or more reception terminals to which the transmission message cancelation command signal is transmitted.

12. The message server as claimed in claim 11, wherein the cancelation command signal is a form of an UNDO message, the UNDO message comprises a reception terminal ID (Unique ID (UID)), a chat room ID (Session ID), a transmission terminal ID (User ID), and a message ID (msID), the cancelation completion signal is a form of an UNDO CONFIRM message, and the UNDO CONFIRM message comprises a transmission terminal ID (Unique ID (UID)), a chat room ID (Session ID), a reception terminal ID (User ID), and a message ID (msID).

13. The message server as claimed in claim 9, wherein the transmission terminal is one of the plurality of terminals associated with the same user account.

14. The message server as claimed in claim 9, wherein the controller checks whether each of the at least one or more reception terminals is supportive of message cancelation, and determines that it is possible to cancel the message for a reception terminal that is supportive of message cancelation among the at least one or more reception terminals as a result of checking.

15. The message server as claimed in claim 9, wherein the controller checks whether each of the at least one or more reception terminals is supportive of message cancelation and is in an idle state, and determines that it is possible to cancel the message for a reception terminal that is supportive of message cancelation and a reception terminal that is unsupportive of message cancelation and is in the idle state among the at least one or more reception terminals as a result of checking.

16. A terminal comprising:
a display;
a communication unit that receives a transmission message and receives a cancelation command signal for the transmission message; and
a processor that, according to the cancelation command signal for the transmission message, processes the transmission message not to be displayed on the display when the transmission message has been read, and displays a message indicating that the transmission message is canceled on the display, instead of displaying the transmission message, when the transmission message has not been read.

17. The terminal as claimed in claim 16, wherein when cancelation of the transmission message is completed, the communication unit transmits a cancelation confirmation signal.

18. The terminal as claimed in claim 16, wherein the processor processes information indicating that there is an unread message not to be displayed on the display when the message to be canceled has not been read.

19. A terminal comprising:
a display;
a communication unit that transmits a message cancelation request for canceling a transmission message transmitted to at least one or more reception terminals; and
a processor that, according to the cancelation request, displays a message indicating that message cancelation is impossible on the display when a message cancelation impossible signal is received, and displays a message cancelation completion signal on the display when the message cancelation completion signal is received.

20. A message service system comprising:
a transmission terminal that transmits a cancelation request for canceling a transmission message transmitted to at least one or more reception terminals;
a message server that determines whether it is possible to cancel the transmission message for each of the at least one or more reception terminals and transmits a transmission message cancelation command signal to a reception terminal for which it is possible to cancel the transmission message among the at least one or more reception terminals; and
the at least one or more reception terminals that cancel a received message according to the transmission message cancelation command signal,
wherein the at least one or more reception terminals comprise a plurality of terminals associated with a same user account.

21. A message service method comprising:
receiving, from a transmission terminal, a cancelation request for canceling a transmission message transmitted to at least one or more reception terminals in a group chat room;
determining whether it is possible to cancel the transmission message for each of the at least one or more reception terminals belonging to the group chat room; and
transmitting a transmission message cancelation command signal to a reception terminal for which it is possible to cancel the transmission message among the at least one or more reception terminals belonging to the group chat room,
wherein the at least one or more reception terminals comprise a plurality of terminals associated with a same user account.
